(19) United States
(12) Patent Application Publication
(10) Pub. No.: US 2021/0186037 A1
(43) Pub. Date: Jun. 24, 2021

(54) FLOUR IMPROVER AND USES THEREOF

(71) Applicant: PURATOS, Groot-Bijgaarden (BE)

(72) Inventors: Ingrid VAN HAESENDONCK, Mechelen (BE); Goedele VAN DER BIEST, Zellik (BE); Bram PAREYT, Kruishoutem (BE); Charles R GALLIHER, III, Cherry Hill, NJ (US); Michael KIME, Philadelphia, PA (US); Geertrui BOSMANS, Antwerpen (BE); Kristof BRIJS, Zwijndrecht (BE); Jan DELCOUR, Heverlee (BE)

(21) Appl. No.: 16/757,918

(22) PCT Filed: Oct. 26, 2018
(86) PCT No.: PCT/EP2018/079433

§ 371 Date: Apr. 21, 2020

(30) Foreign Application Priority Data
Oct. 27, 2017 (BE) 2017/5771

(51) Int. Cl. A21D 2/02; A21D 13/047; A21D 2/26; A21D 10/00; A21D 10/04; A21D 13/80

(52) U.S. Cl. CPC A21D 2/02; A21D 13/047; A21D 2/263; A21D 13/80; A21D 2/266; A21D 10/005; A21D 10/04; A21D 2/262

(57) ABSTRACT

Flour improvers, chlorinated flour replacers comprising the flour improver, methods of preparing the flour improvers and chlorinated flour replacers, and uses thereof (e.g. for improving the textural properties of wheat flour-based high ratio cakes) are provided. The flour improver as disclosed herein comprises between 10% and 97.5% (w/w) of non-wheat flour, wherein the non-wheat flour is one or more non-wheat flours selected from the group consisting of rice flour, oat flour, quinoa flour and buckwheat flour; between 2% and 20% (w/w) of a gel-forming protein in addition to protein present in the non-wheat flour; and between 0.5% and 3% (w/w) of calcium 2+ ions.

### FIELD OF THE INVENTION

The present invention belongs to the technical field of food processing. More specifically, the present invention relates to cakes and more particularly to new compositions for making cakes, and to methods for producing such products.

### BACKGROUND

Cakes are chemically leavened batter-based baked products prepared with four major ingredients present in different ratios depending on the type of cake: flour, sugar, fat and eggs or egg products. Cakes may be aerated due to addition of ingredients (e.g. baking powder, egg, emulsifier, protein, etc.) and/or due to the cake preparation process (e.g. whipping of the batter). Additional ingredients may be for example, emulsifiers, (milk) proteins, hydrocolloids, gums, starch (native, chemically or physically modified), cocoa powder, enzymes and aromas.

Cake recipes are often classified as high ratio and low ratio. A high ratio cake is one in which the level of the sugar or the level of the liquid or the level of both exceeds the level of the flour used in the formulation. If the levels of sugar and liquids are lower than that of the flour then the products are commonly considered as low ratio. A proper high ratio cake with acceptable volume, crumb structure and crumb texture (i.e. no collapse during or after baking) typically requires the use of chlorinated flour (i.e. flour treated with chlorine gas (Cl₂)) and possibly emulsified shortening. Chlorinated cake flour improves the structure-forming capacity, allowing the use of dough or batter formulas with lower proportions of flour and higher proportions of sugar and/or liquids. High ratio cakes prepared with chlorinated flour typically have a very fine and white crumb structure and a specific cake crumb texture with good resilience, springiness and chewiness. Chlorinated flour can also be used for the production of cream cake, pound cake, sponge cake, muffins, cake donuts, cup cream and pound cakes, and brownies.

The use of Cl₂ to treat flour raised concerns during the 1980/1990s due to the safety issues related to the handling of Cl₂ in the flour milling industry, as well as concerns over the use of Cl₂ in foods. Use of bleached or chlorinated wheat flour in cake applications and bakery applications has been banned by the European Food Safety Authority (EFSA) in 1995.

Furthermore, consumers are nowadays looking for more natural cakes with less and/or better understandable additives that do not induce a health risk (e.g. no aluminium, no bleached flour).

Today some high ratio cakes are produced using physically modified flour. For example, heat treated flour, turbo milled flour, wind-sifted flour or flour treated with a combination of the above described physical treatments. Also combinations of flours, physically modified flour and sources of starch and protein are used to replace chlorinated flour in cake applications.

EP549212A1/EP0020170B1 (Cakes mixes utilizing unchlorinated wheat flour), describes the composition and production of cakes based on unchlorinated wheat flour (e.g. soft or hard wheat flour), unmodified starch (wheat, oat, rice) and a protein source (whey, egg white).

U.S. Pat. No. 4,294,864 (preparation of high ratio cakes using untreated wheat flour) describes batter formulations for making high ratio cakes, based on untreated wheat flour. The resulting end products are essentially equivalent in terms of organoleptic properties and shelf life to those made using chlorinated cake flour. The batter compositions comprise untreated wheat flour in combination with minor amounts of one or more selected proteins and unmodified (granular) starch.

Chlorinated flour is very cheap; it is hardly more expensive than untreated flour. The currently existing solutions to replace chlorinated flour in high ratio cake applications are significantly more expensive and result for the consumer in an unacceptable cost increase of the finished good. Furthermore existing alternative solutions often prevent the collapse of the cake, but result in less resilient and springy cake textures.

There is therefore a need for new compositions and methods to replace chlorinated flour in the preparation of high ratio cakes that do not substantially exceed the costs of chlorinated flour, and that result in high quality cakes with superior texture properties over the prior art.

### SUMMARY OF THE INVENTION

The inventors have surprisingly found that a combination of non-wheat flour (e.g. rice flour, oat flour, quinoa flour and/or buckwheat flour), proteins (e.g. food-derived gel-forming proteins) and calcium 2+ ions functions as a flour improver as the use of such a combination in the preparation of cake (e.g. a high ratio cake) based on non-chlorinated flour unexpectedly improved the textural properties of said cake (e.g. hardness, resilience and/or chewiness, preferably resilience and/or chewiness). Even more, the improvement of the cake texture given by the combination of the three ingredients in the flour improver is larger than the sum of the effects of the ingredients taken individually. There is a synergy when the effect given by amount “X” of the non-wheat flour combined with amount “Y” of protein and amount “Z” of calcium 2+ ions is larger than the sum of the effect given by amount “X” of the non-wheat flour, the effect given by the amount “Y” of protein and the effect given by the amount “Z” of calcium 2+ ions.

A first aspect provides a flour improver, in the form of a powder or dry blend, for use in the preparation of wheat flour-based high ratio cakes, the flour improver comprising:
between 10% and 97.5% (w/w) of non-wheat flour, wherein the non-wheat flour is one or more non-wheat flours selected from the group consisting of rice flour, oat flour, quinoa flour and buckwheat flour;
between 2% and 20% (w/w) of a gel-forming protein in addition to protein present in the non-wheat flour; and
between 0.5% and 3% (w/w) of calcium 2+ ions.

A further aspect as disclosed herein provides a chlorinated flour replacer for use in the preparation of wheat flour-based high ratio cakes, the chlorinated flour replacer comprising:
between 7% and 60% (w/w) of the flour improver as disclosed herein; and
between 40% and 93% (w/w) of non-chlorinated wheat flour.

In particular embodiments, the chlorinated flour replacer as disclosed herein comprises:
between 40% and 88.75% (w/w) of non-chlorinated wheat flour;
between 10% and 58% (w/w), preferably between 10% and 25% (w/w), of non-wheat flour, wherein the non-wheat flour is one or more non-wheat flours selected from the group consisting of rice flour, oat flour, quinoa flour and buckwheat flour;
between 1% and 10% (w/w), preferably between 2% and 4% (w/w), of the gel-forming protein in addition to protein present in the non-chlorinated wheat flour and the non-wheat flour; and
between 0.25% and 1% (w/w), preferably between 0.25% and 0.8% (w/w), of calcium 2+ ions.

In particular embodiments, the non-wheat flour in the flour improver as disclosed herein or in the chlorinated flour replacer as disclosed herein is rice flour, preferably wet milled rice flour.

In particular embodiments, the gel-forming protein in addition to the protein present in the non-chlorinated wheat flour and the non-wheat flour in the flour improver as disclosed herein or in the chlorinated flour replacer as disclosed herein is one or more gel-forming proteins selected from the group consisting of egg protein, casein, whey protein, isolated wheat gluten, oilseed protein and legume protein.

In particular embodiments, the calcium 2+ ions in the flour improver as disclosed herein or in the chlorinated flour replacer as disclosed herein are present in the form of one or more calcium salts selected from the group consisting of calcium chloride, calcium acetate, calcium citrate, calcium lactate, calcium tartrate, calcium glubionate and calcium gluceptate.

A further aspect as disclosed herein provides a cake batter comprising the flour improver as disclosed herein, non-chlorinated wheat flour, fat, eggs or egg products, sugar or sugar substitutes, leavening agent and water; wherein the ratio (w/w) of liquid to flour is between 1 and 3.

In particular embodiments, the cake batter as disclosed herein, comprises:
between 0.35% and 17.5% (w/w) of the flour improver as disclosed herein;
between 2.5% and 32.6% (w/w) of non-chlorinated wheat flour;
between 2% and 35% (w/w) of fat;
between 5% and 40% (w/w) of eggs or egg products;
between 10% and 40% (w/w) of sugar or sugar substitutes;
between 0% and 2.5% (w/w) of leavening agent; and
water up to 100%.

In particular embodiments, the ratio (w/w) of sugar or sugar substitutes to flour in the cake batter as disclosed herein is between 0.7 and 3.0.

In particular embodiments, the cake batter as disclosed herein, further comprises one or more emulsifiers, aroma components, flavour components, hydrocolloids, reducing agents, oxidants, yeast extract, enzyme active soy flour, starches, cocoa powder, chocolate, colouring agents, and/or enzymes.

A further aspect as disclosed herein provides the use of the flour improver as disclosed herein; the chlorinated flour replacer as disclosed herein; or the cake batter as disclosed herein, as an ingredient in the preparation of a wheat flour-based high ratio cake, particularly in the preparation of a wheat flour-based high ratio cake based on non-chlorinated wheat flour, preferably wherein the flour improver or the chlorinated flour replacer is used as part of a cake mix or a cake premix.

A further aspect as disclosed herein provides a cake product prepared from the cake batter as disclosed herein, wherein said cake product is a wheat flour-based high ratio cake.

A further aspect as disclosed herein provides a method for preparing the flour improver as disclosed herein, comprising the step of preparing a mixture of at least:
between 10% and 97.5% (w/w) of non-wheat flour, wherein said non-wheat flour is one or more non-wheat flours selected from the group consisting of rice flour, oat flour, quinoa flour and buckwheat flour;
between 2% and 20% (w/w) of a gel-forming protein in addition to protein present in the non-chlorinated wheat flour and the non-wheat flour; and
between 0.5% and 3% (w/w) of calcium 2+ ions, thereby obtaining the flour improver as described herein.

A further aspect as disclosed herein provides a method for preparing the chlorinated flour replacer as disclosed herein, comprising the step of preparing a dry mixture of at least:
between 40% and 88.75% (w/w), preferably between 70% and 80% (w/w) of non-chlorinated wheat flour;
between 10% and 58% (w/w), preferably between 10% and 25% (w/w), of non-wheat flour wherein said non-wheat flour is one or more non-wheat flours selected from the group consisting of rice flour, oat flour, quinoa flour and buckwheat flour;
between 1% and 10% (w/w), preferably between 2% and 4% (w/w), of a gel-forming protein in addition to protein present in the non-chlorinated wheat flour and the non-wheat flour; and
between 0.25% and 1% (w/w), preferably between 0.2 5% and 0.8% (w/w), of calcium 2+ ions, thereby obtaining the chlorinated flour replacer as described herein.

A further aspect as disclosed herein provides a method for preparing a cake batter as disclosed herein, comprising the steps of adding the flour improver as disclosed herein to non-chlorinated flour, fat, eggs or egg products, sugar or sugar substitutes, leavening agent and water and ensuring that the ratio (w/w) of liquid to flour is between 1 and 3, and optionally ensuring that the ratio (w/w) of sugar to flour is between 0.7 and 3.0; thereby obtaining the cake batter.

A further aspect as disclosed herein provides a method for preparing a cake product as disclosed herein, comprising the steps of providing a flour improver as disclosed herein or a chlorinated flour replacer as disclosed herein; adding the flour improver or the chlorinated flour replacer to a batter; and baking the batter, thereby obtaining the cake product.

A further aspect as disclosed herein provides the use of the flour improver as disclosed herein or the chlorinated flour replacer as disclosed herein for improving the textural properties of wheat flour-based high ratio cakes, particularly of non-chlorinated wheat flour based high ratio cakes.

A further aspect as disclosed herein provides the use of the flour improver as disclosed herein or the chlorinated flour replacer as disclosed herein for increasing the resilience of a wheat flour-based high ratio cake by at least 20%, preferably at least 30%, more preferably at least 40%, compared to the resilience of a reference wheat flour-based high ratio cake, wherein said reference high ratio cake is a high ratio cake prepared using untreated wheat flour instead of the chlorinated flour replacer.

A further aspect as disclosed herein provides the use of the flour improver as disclosed herein or the chlorinated flour replacer as disclosed herein for increasing the chewiness of a wheat flour-based high ratio cake by at least 30%, preferably at least 40%, compared to the chewiness of a reference wheat flour-based high ratio cake, preferably wherein said reference high ratio cake is a high ratio cake prepared using untreated wheat flour instead of the chlorinated flour replacer.

### BRIEF DESCRIPTION OF THE FIGURES

FIG. 1 shows the gelling properties of four protein samples, i.e. (A) whey protein (Nutrilac, Arla Foods Ingredients, Denmark); (B) egg white powder; (C) pea protein (Nutralys S85F, Roquette, France) and (D); skimmed milk powder, as evaluated during a temperature-time heating cycle with a Rapid Visco Analyzer (RVA, Perten Instruments model RVA 4, Perten, Germany). The solid line shows the temperature profile to which the samples were subjected.

### DETAILED DESCRIPTION

The present invention will be described with respect to particular embodiments but the invention is not limited thereto but only by the claims. Any reference signs in the claims shall not be construed as limiting the scope thereof.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” when referring to recited members, elements or method steps also include embodiments which “consist of” said recited members, elements or method steps.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +1-0.1% or less of and from the specified value, insofar such variations are appropriate to perform in the disclosed invention. It is to be understood that the value to which the modifier “about” refers is itself also specifically, and preferably, disclosed.

The recitation of numerical ranges by endpoints includes all numbers and fractions subsumed within the respective ranges, as well as the recited endpoints.

All documents cited in the present specification are hereby incorporated by reference in their entirety.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The inventors have surprisingly found that a combination of non-wheat flour (e.g. rice flour, oat flour, quinoa flour and/or buckwheat flour), a gel-forming protein in addition to the protein present in the non-wheat flour, and calcium 2+ ions functions as a flour improver as the use of such a combination in the preparation of high ratio cakes unexpectedly improved the textural properties of said cake (e.g. hardness, resilience and/or chewiness, preferably resilience and/or chewiness) based on non-chlorinated wheat flour. More particularly, the new ingredient combination allowed preparing high ratio cakes without using chlorinated wheat flour and/or heat-treated flour that have textural properties comparable to those of high ratio cakes made conventionally with chlorinated flour and/or heat-treated flour. Moreover, the new ingredient combination allowed preparing high ratio cakes without using chlorinated wheat flour and/or heat-treated flour that have textural properties greater than those of high ratio cakes made with non-treated flour in absence of the new ingredient mixture.

Furthermore, the inventors have found an unexpected synergy on the textural properties of high ratio cakes between the ingredients (i.e. non-wheat flour, proteins (preferably gel-forming proteins) and calcium 2+ ions) used. The improvement of the cake texture given by the combination of the three ingredients in the flour improver is larger than the sum of the effects of the ingredients taken individually. There is a synergy when the effect given by amount “X” of the non-wheat flour combined with amount “Y” of protein and amount “Z” of calcium 2+ ions is bigger than the sum of the effect given by amount “X” of the non-wheat flour, the effect given by the amount “Y” of protein and the effect given by the amount “Z” of calcium 2+ ions.

Additionally, the costs of the new ingredient combination do not substantially exceed those of chlorinated or heat-treated flour.

Accordingly, a first aspect of the invention provides a flour improver, particularly in the form of a powder or dry blend, for use in the preparation of wheat flour-based high ratio cakes comprising (in % by weight of the flour improver):
between 10% and 97.5% (w/w) of non-wheat flour, wherein said non-wheat flour is one or more non-wheat flours selected from the group consisting of rice flour, oat flour, quinoa flour and buckwheat flour;
between 2% and 20% (w/w) of a gel-forming protein in addition to protein present in the non-wheat flour; and
between 0.5% and 3% (w/w) of calcium 2+ ions.

The term “flour improver” (also referred to as “flour conditioner” or “improving agent” or “flour treatment agent”) as used herein refers to one or more substances added to a dough or a batter prior to or during baking in order to improve texture, volume, flavour and/or freshness of the baked product, and/or to improve machinability and stability of the dough or batter.

The term “cake” as used herein refers to a batter-based baked product containing as main ingredients (wheat) flour, sugar, fat and eggs or egg products. Depending on the type of cake, the ratio of flour, sugar and eggs or egg products will vary. Cakes may be aerated due to addition of ingredients (e.g. baking powder, egg, emulsifier, protein, etc.) and/or due to the cake preparation process (e.g. whipping of the batter). In the context of the present invention a cake product may be any cake product known in the art. Non-limiting examples of cakes are loaf cream and pound cakes, cup cream and pound cakes, sponge cakes, muffins, cake donuts and brownies.

The term “wheat flour-based” as used herein refers to cakes wherein the amount of wheat flour is equal to or higher than the amount of non-wheat flour, preferably higher than the amount of non-wheat flour. For example, the cake batter may comprise between 2.5% and 32.6% (w/w) of non-chlorinated wheat flour and between 0.035 and 17.06% (w/w) of non-wheat flour, wherein the amount of wheat flour is higher than the amount of non-wheat flour.

The term “high ratio cake” as used herein, refers to a cake or cake product which is prepared from a cake batter wherein the amount of liquids or the amounts of both the liquids and the sugar or sugar substitutes is equal to or exceeds the amount of the flour. Since a cake needs enough liquid to dissolve all of the sugar, the presence of more liquid typically permits more sugar. The liquid-to-flour ratio in the cake batter for preparing a high ratio cake may range from 1 to 3, and optionally the sugar-to-flour ratio in the cake batter for preparing a high ratio cake may range from 0.7 to 3. High ratio cakes typically require the presence of ingredients, such as finely ground cake flour or chlorinated flour, which are able to absorb and/or bind the liquid in the cake batter, and/or emulsifiers. In particular embodiments, the high ratio cake may be prepared from a cake batter having a ratio (w/w) of sugar (or sugar substitutes) to flour between 0.7 and 3.0 and a ratio (w/w) of liquid to flour of between 1 and 3. The flour as referred to in the ratio (w/w) of sugar (or sugar substitutes) to flour refers to all flour present in the cake batter.

In particular embodiments, the high ratio cake may be a loaf cream and pound cake, a cup cream and pound cake, a sponge cake, a muffin, a cake donut or a brownie. In particular embodiments, the high ratio cake is a chemically leavened cake. The term “chemical leavening” as used herein refers to the generation of carbon dioxide gas from added chemical reactants (e.g. baking powder) as their leavening source in controlled volumes and rates in a bakery product. Chemical leavening is typically used to aerate the dough or batter rendering it light and porous. The bubbles created during mixing expand by the leavening during baking creating the baked product's crumb structure. Generally recognized leavening agents may include monocalcium phosphate (Ca(H₂PO₄)₂), sodium aluminium sulphate (NaAl(SO₄)₂.12H₂O), disodium pyrophosphate (Na₂H₂P₂O₇), and sodium aluminium phosphates (NaH₁₄Al₃(PO₄)₈.4H₂O and Na₃H₁₅Al₂(PO₄)₈).

The term “non-wheat flour” is the product obtained by grinding grains, nuts, legumes, fruits and/or vegetables. Non-limiting examples of non-wheat flour are rice flour, oat flour, buckwheat flour, almond flour, amaranth flour, arrowroot flour, barley, bean (e.g. chickpea, soy) flour, bulger flour, chestnut flour, chia seed flour, quinoa flour, coconut flour, cornmeal and corn flour.

In particular embodiments, the non-wheat flour may be heat-treated. Preferably, the non-wheat flour may be heat-treated at a temperature between 98° C. and 140° C. More preferably, the non-wheat flour may be heat-treated at a temperature between 98° C. and 140° C. for a period between 60 and 240 minutes.

In particular embodiments, the non-wheat flour may be non-fractionated non-wheat flour.

In particular embodiments, the non-wheat flour may be gluten-free.

In particular embodiments, the non-wheat flour may be dry milled or wet milled non-wheat flour. Preferably, the non-wheat flour is wet milled non-wheat flour. Dry milling and wet milling are conventional milling methods well known in the art and give products with different properties. As described earlier, the non-wheat flour is one or more non-wheat flour selected from the group consisting of rice flour, oat flour, quinoa flour and buckwheat flour. In particular embodiments, the non-wheat flour is a combination of rice flour, oat flour, quinoa flour and/or buckwheat flour.

Present inventors have found that the use of wet milled rice flour as non-wheat flour in the flour improver as described herein provides a cake product with a better resilience compared to the use of dry milled rice flour as non-wheat flour. Accordingly, in preferred embodiments, the non-wheat flour is wet milled rice flour. In particular embodiments, the non-wheat flour may be wet or dry milled gluten-free oat flour made from kilned kernels, preferably dry milled gluten-free oat flour made from kilned kernels.

In particular embodiments, the non-wheat flour may be dry milled buckwheat flour.

In particular embodiments, the flour improver may comprise between 10% and 97.5% (w/w), between 20% and 95% (w/w), between 30% and 90% (w/w), or between 80% and 90% (w/w) of non-wheat flour, wherein said non-wheat flour is one or more non-wheat flours selected from the group consisting of rice flour, oat flour, quinoa flour and buckwheat flour. Preferably, the flour improver may comprise between 30% and 90% (w/w) of non-wheat flour, wherein said non-wheat flour is one or more non-wheat flours selected from the group consisting of rice flour, oat flour, quinoa flour and buckwheat flour, particularly rice flour, more particularly wet-milled rice flour.

The term “protein” as used herein generally encompasses macromolecules comprising one or more polypeptide chains, i.e., polymeric chains of amino acid residues linked by peptide bonds. The term may encompass proteins of natural, recombinant, semi-synthetic or synthetic origin. The term also encompasses proteins that carry one or more co- or post-expression-type modifications of the polypeptide chain(s), such as, without limitation, glycosylation, acetylation, phosphorylation, sulfonation, methylation, ubiquitination, signal peptide removal, N-terminal Met removal, conversion of pro-enzymes or pre-hormones into active forms, etc. The term further also includes protein variants or mutants which carry amino acid sequence variations vis-à-vis corresponding native proteins, such as, e.g., amino acid deletions, additions and/or substitutions. The term further also includes proteins that have been oxidized or reduced. The term contemplates both full-length proteins and protein parts or fragments, e.g., naturally-occurring protein parts that ensue from processing of such full-length proteins. The term may encompass mixtures of different proteins.

The term “gel-forming” as used herein refers to the ability of a molecule (e.g. a protein) to form a viscoelastic aggregate, particularly upon heating, also called a gel (i.e. gelling or gelation). A protein gel is a three-dimensional network in which polymer-polymer and polymer-solvent interactions occur in an ordered manner, resulting in the immobilization of large amounts of water by a small proportion of protein. A gel may be formed from proteins when partially unfolded proteins develop uncoiled polypeptide segments that interact at specific points to form a three dimensional such as a coagulum or a cross-linked network. Partial unfolding of proteins with slight changes in secondary structure is typically required for gelation. Partial unfolding of the native structure can be related to the action of various factors such as heating, treatment with enzymes, acids, alkali and/or urea. The protein may form a gel spontaneously or by heat- and/or enzyme-induction, preferably by heat-induction. The type of forces that hold a gel together will depend on the characteristics of the native protein. These include hydrophobic interaction, hydrogen bonding, electrostatic interaction, and/or disulfide cross-links. It is understood by the skilled person that gel-forming or gelling proteins as considered herein can easily be distinguished from non-gelling proteins by measuring the changes in rheological properties during heating, such as during heating from 20° C. to 95° C., from 30° C. to 95° C. or from 40° C. to 95° C., such as from 50° C. to 90° C. or from 50° C. to 95° C., at a heating rate between 0.5 and 10° C./min. For instance, gel-forming or gelling proteins as considered herein can easily be distinguished from non-gelling proteins by performing a “Rapid Visco Analyser” analysis, wherein the protein sample is subject to a heating step from 5° C. to 95° C. at a heating rate between 1 and 10° C./min, such as at a heating rate of 6° C./min. In such an analysis the viscosity of a non-gelling protein solution will (essentially) not increase with the temperature increase.

In particular embodiments, the gel-forming protein in addition to protein present in the non-wheat flour is a food-derived or food protein (i.e. isolated from a food source).

Preferably, the protein is from plant or animal origin.

In particular embodiments, the gel-forming protein in addition to protein present in the non-wheat flour is added to and/or is present in the flour improver in the form of a protein source which has a protein content of at least 70% (w/w), preferably at least 80% (w/w). In particular embodiments, the gel-forming protein in addition to protein present in the non-wheat flour may be isolated from a source selected from rye, cottonseed, peanut, canola, legume (e.g. soy, pea, or lupine), egg, egg white, milk, whey or wheat protein. In more particular embodiments, the protein may be isolated from a source selected from defatted roasted soy flour, active defatted soy flour, defatted canola press cake, rye flour, cottonseed, pea flour, egg whites, non-fat dry milk, whey, wheat protein concentrate and mixtures thereof. Non-limiting exemplary sources for such protein are defatted roasted soy flour, active defatted soy flour, soy isolates, canola protein isolates, cottonseed flour, pea flour, egg whites, non-fat dry milk, whey, wheat protein concentrate, rye flour and mixtures thereof.

Non-limiting examples of gel-forming proteins in addition to the protein present in non-wheat flour are casein, whey protein (preferably gel-forming whey protein), isolated wheat gluten, legume protein (preferably gel-forming legume protein) and egg protein. Non-egg proteins may be subjected to a limited hydrolysis, e.g. enzymatic hydrolysis. The (hydrolysed) protein(s) may be enzymatically modified, e.g. with a cross-linking enzyme such as transglutaminase or another protein modifying enzyme such as protein-glutaminase. Furthermore the protein may be modified physically or chemically, e.g. through denaturation and/or deamidation.

In particular embodiments, the gel-forming protein in addition to the protein present in non-wheat flour is one or more proteins selected from the group consisting of egg protein, casein, whey protein (preferably gel-forming whey protein), isolated wheat gluten, oilseeds protein and legume protein In preferred embodiments, the gel-forming protein in addition to the protein present in non-wheat flour is added to and/or is present in the flour improver under the form of whey powder (preferably gel-forming whey powder) or egg white powder.

In particular embodiments, the flour improver may comprise between 2% and 20% (w/w), between 4% and 18% (w/w), between 6% and 15% (w/w) or between 10% and 15% (w/w), of a gel-forming protein in addition to the protein present in non-wheat flour. Preferably, the flour improver may comprise between 6% and 15% (w/w) of a gel-forming protein in addition to the protein present in non-wheat flour. For example, the flour improver comprises 12% (w/w) of a gel-forming protein in addition to the protein present in non-wheat flour.

The term “calcium (2+) ions” refers to the chemical element with symbol “Ca” or “Ca²⁺” and atomic number 20. Calcium has two valence electrons in the outermost s-orbital, which are very easily lost in chemical reactions to form a dipositive ion with the stable electron configuration of a noble gas, in this case argon.

In particular embodiments, the calcium 2+ ions may be present in the flour improver in the form of a calcium source, such as a calcium salt.

In particular embodiments, the calcium 2+ ions may be present in the flour improver in the form of a calcium salt, wherein the calcium salt is one or more calcium salts selected from the group consisting of calcium chloride, calcium acetate, calcium citrate, calcium lactate, calcium tartrate, calcium glubionate and calcium gluceptate. Preferably, the calcium 2+ ions are present in the form of calcium chloride (CaCl₂) or calcium acetate. In particular embodiments, the flour improver may comprise between 0.5% and 3% (w/w), between 0.7% and 2% (w/w), or between 0.9% and 1.6% (w/w) of calcium 2+ ions, particularly of soluble calcium ions. Preferably, the flour improver may comprise between 0.9% and 1.3% (w/w) of calcium 2+ ions.

In particular embodiments, the flour improver comprises between 0.5% and 5.0% (w/w) of a calcium salt as the calcium source, preferably between 0.5% and 4% (w/w), more preferably between 0.5% and 3% of a calcium salt as the calcium source.

In particular embodiments, the flour improver for use in the preparation of wheat flour-based high ratio cakes may comprise (in % by weight of the flour improver):
between 20% and 95% (w/w), between 30% and 90% (w/w), or between 80% and 90% (w/w), preferably between 30% and 90% (w/w) of non-wheat flour, wherein said non-wheat flour is one or more non-wheat flours selected from the group consisting of rice flour, oat flour, quinoa flour and buckwheat flour;
between 4% and 18% (w/w), between 6% and 15% (w/w), or between 10% and 15% (w/w), preferably between 6% and 15% (w/w), of a gel-forming protein in addition to protein present in the non-chlorinated wheat flour and the non-wheat flour; and
between 0.7% and 2% (w/w), or between 0.9% and 1.6% (w/w), preferably between 0.9% and 1.3% (w/w), of calcium 2+ ions.

In more particular embodiments, the flour improver for use in the preparation of wheat flour-based high ratio cakes may comprise (in % by weight of the flour improver):
between 30% and 90% (w/w) or between 80% and 90% of non-wheat flour, wherein said non-wheat flour is one or more non-wheat flours selected from the group consisting of rice flour, oat flour, quinoa flour and buckwheat flour;
between 6% and 15% (w/w), of a gel-forming protein in addition to protein present in the non-chlorinated wheat flour and the non-wheat flour; and
between 0.9% and 1.3% (w/w), of calcium 2+ ions.

As indicated above, present inventors surprisingly found that the new ingredient combination comprising specific amounts of non-wheat flour, gel-forming protein and calcium 2+ ions allowed preparing high ratio leavened cakes without using chlorinated wheat flour and/or heat-treated flour that have textural properties comparable to those of wheat flour-based high ratio cakes made conventionally with chlorinated flour and/or heat-treated flour. Accordingly, the addition of the new ingredient combination comprising specific amounts of non-wheat flour, gel-forming protein and calcium 2+ ions (i.e. the flour improver as described herein) to non-chlorinated flour can be used as a favourable chlorinated flour replacer for the preparation of cakes.

In view of the above, a further aspect provides the use of the flour improver as described herein in a chlorinated flour replacer.

A further aspect of the invention provides a chlorinated flour replacer for use in the preparation of high ratio leavened cakes comprising (in % by weight of the chlorinated flour replacer):
between 7% and 60% (w/w) of the flour improver as described herein; and
between 40% and 93% (w/w) of non-chlorinated wheat flour.

The term “non-chlorinated flour” as used herein refers to flour that has not been subjected to a chlorination treatment with chlorine gas (Cl₂). Traces (i.e. less than 5% (w/w)) of chlorinated flour may be (accidentally) present in the non-chlorinated flour. Chlorinated flour is typically obtained by treating flour with Cl₂. Chlorine gas reacts with water in the flour (flour typically has a moisture content around 14%) according to the equation: Cl₂+3H₂O→2H₃O+ . . . +OCl⁻+Cl⁻. The formed hypochlorite ion (OCl⁻) is a strong oxidizing agent. It acts on flour pigments (i.e. carotenoids that are part of the lipid fraction) and decreases their levels. This bleaches the flour. The formed hydrogen ions lower flour pH. Chlorination of the flour may be monitored by a decrease in pH. Chlorinated flour may be used to prevent collapsing of cakes during baking. Cakes prepared from chlorinated flour typically have an increased volume and white, finer and more even crumb, compared to cakes prepared from non-chlorinated flour.

In particular embodiments, the non-chlorinated wheat flour may comprise less than 5%, less than 1%, less than 0.5%, less than 0.1%, preferably 0% of traces of chlorinated flour. In particular embodiments, the non-chlorinated wheat flour may be non-heat-treated and non-chlorinated wheat flour.

In particular embodiments, the non-chlorinated wheat flour may be untreated wheat flour. The term “untreated” refers to lack of significant treatment conventionally used to render wheat flour acceptable for high ratio cake batter compositions. That is to say, it is conventional to provide chlorinated flour or in some instances heat treated flour, turbo milled flour and/or wind sifted flour for employment in high ratio batter compositions; the term “untreated” in accordance with the invention simply means that the conventional treatment for such flours has been omitted.

In particular embodiments, the chlorinated flour replacer comprises:
between 10% and 60% (w/w), between 10% and 55%, between 20% and 50% (w/w), or between 20% and 30% (w/w), preferably between 20% and 30% (w/w) of the flour improver as described herein; and
between 40% and 90% (w/w), between 40% and 88.75% (w/w), between 45% and 90%, between 45% and 88.75% (w/w), between 50% and 80% (w/w), between 70% and 90% (w/w), or between 70% and 88.75% (w/w), preferably between 70% and 80% (w/w) of non-chlorinated wheat flour.

The term “wheat flour” as used herein refers to flour produced by the milling of wheat. Wheat flour typically has the potential to produce gluten, which is a protein that imparts strength and elasticity to a dough or batter and influences the texture of baked goods. The gluten content of wheat flour depends on whether the flour is made from hard (i.e. strong) or soft (i.e. weak) wheat. Hard wheats are typically higher in protein than soft wheats, and thus produce more gluten. For example, hard wheat may have a protein content of between 12 and 14% (w/w). Most flour is a mixture of hard and soft wheat. Wheat flour can be available in many varieties. The skilled person will understand that the categorization of wheat flours is regional and that the same name may have several different regional meanings. For example, on the one hand, North American soft cultivars of T. aestivum wheats, which are easy to crush, are typically used for the preparation of cookies (biscuits), while the hard cultivars, which are more difficult to crush, are typically used in the production of bread and yeast-raised products. On the other hand, in some European countries, the term soft wheat is typically used for both non-breadmaking and breadmaking T. aestivum wheats, while the term hard wheat typically refers to T. durum, the normal raw material for pasta production.

In particular embodiments, the wheat flour may be soft or hard wheat flour, or a combination thereof. Ratios of soft to hard wheat flour may vary from 1:99 to 99:1. In particular embodiments, the wheat flour may be soft wheat flour, preferably soft wheat flour with a protein content of less than 10% (w/w), even more preferably North American soft wheat flour conventionally used for the production of cakes in North America or an equivalent thereof.

In particular embodiments, the wheat flour may be cake flour. The term “cake flour” as used herein refers to finely milled white flour made from soft wheat, which has a protein content between 8% and 10% (w/w) and is suitable for the preparation of (soft-textured) cakes, biscuits and cookies.

In particular embodiments, the chlorinated flour replacer may comprise between 20% and 50% (w/w), or between 20% and 40% (w/w), preferably between 20% and 30% (w/w) of the flour improver as described herein, and between 50% and 80% (w/w), or between 60% and 80% (w/w), preferably between 70% and 80% (w/w) of non-chlorinated wheat flour.

In particular embodiments, the chlorinated flour replacer comprising the flour improver as described herein may comprise (in % by weight of the chlorinated flour replacer):
between 40% and 88.75% (w/w) of non-chlorinated wheat flour;
between 10% and 58% (w/w) of non-wheat flour, wherein said non-wheat flour is one or more non-wheat flours selected from the group consisting of rice flour, oat flour, quinoa flour and buckwheat flour;
between 1% and 10% (w/w) of a gel-forming protein in addition to protein present in the non-chlorinated wheat flour and the non-wheat flour; and
between 0.25% and 1% (w/w) of calcium 2+ ions.

In particular embodiments, the chlorinated flour replacer may comprise between 10% and 50% (w/w), between 10% and 40% (w/w), between 10% and 30% (w/w), between 15% and 25% (w/w), between 20% and 25% (w/w), preferably between 10% and 25% (w/w) of non-wheat flour.

In particular embodiments, the chlorinated flour replacer may comprise between 1% and 10% (w/w), between 1% and 5% (w/w), between 2% and 5% (w/w), between 1% and 4% (w/w), preferably between 2% and 4% (w/w) of a gel-forming protein in addition to protein present in the non-chlorinated wheat flour and the non-wheat flour. For example, the chlorinated flour replacer comprises 3% (w/w) of a gel-forming protein in addition to protein present in the non-chlorinated wheat flour and the non-wheat flour.

The skilled person will understand that the particular embodiments relating to the gel-forming protein in addition to protein present in the non-wheat flour in the flour improver also apply to the gel-forming protein in addition to protein present in the non-chlorinated wheat flour and the non-wheat flour in the chlorinated flour replacer.

In particular embodiments, the gel-forming protein in addition to the protein present in non-wheat flour and non-chlorinated wheat flour may be one or more proteins selected from the group consisting of egg protein, casein, whey protein (preferably gel-forming whey protein), isolated wheat gluten, oilseeds protein and legume protein (preferably gel-forming legume protein). Preferably, the gel-forming protein in addition to the protein present in non-wheat flour and non-chlorinated wheat flour is whey powder (preferably gel-forming whey powder) or egg white powder.

In particular embodiments, the chlorinated flour replacer may comprise between 0.25% and 0.90% (w/w), preferably between 0.25% and 0.80% (w/w) of calcium 2+ ions. In particular embodiments, the chlorinated flour replacer may comprise between 0.25% and 3% (w/w) of a calcium source, preferably wherein said calcium source is calcium chloride (CaCl₂) or calcium acetate.

The chlorinated flour replacer comprising the flour improver as disclosed herein may comprise for example the following ingredients, typically in the following amounts (in % by weight of the chlorinated flour replacer):
between 60 and 80% (w/w), preferably between 70 and 80% (w/w) of non-chlorinated wheat flour;
between 10 and 30% (w/w), preferably between 10 and 25% (w/w), of non-wheat flour wherein said non-wheat flour is one or more non-wheat flours selected from the group consisting of rice flour, oat flour, quinoa flour and buckwheat flour;
between 2 and 4% (w/w) of a gel-forming protein in addition to the protein present in the non-chlorinated wheat flour and the non-wheat flour; and
between 0.25 and 0.9% (w/w), preferably between 0.25 and 0.8% (w/w), of calcium 2+ ions.

The chlorinated flour replacer comprising the flour improver as disclosed herein may comprise for example the following ingredients, typically in the following amounts (in % by weight of the chlorinated flour replacer):
between 60 and 80% (w/w), or between 70 and 80% (w/w) of non-chlorinated wheat flour;
between 10 and 30% (w/w), or between 10 and 25% (w/w), of non-wheat flour wherein said non-wheat flour is one or more non-wheat flours selected from the group consisting of rice flour, oat flour, quinoa flour and buckwheat flour;
between 2 and 4% (w/w) of a gel-forming protein in addition to the protein present in the non-chlorinated wheat flour and the non-wheat flour; and
between 0.5 and 3.0% (w/w) of a calcium salt as the calcium source, preferably wherein said calcium salt is calcium chloride (CaCl₂) or calcium acetate.

A further aspect provides the use of the flour improver or the chlorinated flour replacer as described herein in a cake batter.

A further aspect provides a cake batter comprising the flour improver as described herein, non-chlorinated wheat flour, fat, eggs or egg products, sugar or sugar substitutes, leavening agent and water; wherein the ratio (w/w) of liquid to flour is between 1 and 3. The term “fat” as used herein refers to fats with short or unsaturated fatty acid chains that are liquid at room temperature (i.e. oils) and/or to fats that are solids at room temperature.

The fat may be of animal and/or plant origin. The fat may be any suitable fat known in the art for preparing high ratio cakes. Non-limiting examples of suitable fats are vegetable oil (e.g. soy oil, sunflower oil, palm oil), shortening (e.g. emulsified shortening or non-emulsified shortening), margarine, butter, powdered fat and fat paste.

The phrase “eggs or egg products” as used herein refers to fresh eggs (e.g. egg white, egg yolk, whole egg), liquid eggs, frozen eggs, powdered eggs (e.g. egg white powder, egg yolk powder, whole egg powder, egg albumin powder) or a combination thereof. The eggs or egg products may be pasteurized.

In particular embodiments, the eggs or egg products may be a combination of egg white powder and egg yolk powder.

The phrase “sugar or sugar substitute” as used herein refers to a food-grade substance with a sweet taste. The sugar or sugar substitute may be any sugar, sugar substitute, or a combination thereof suitable for use in the preparation of high ratio cakes. Sugar substitutes may also be artificial sweeteners. Non-limiting examples of sugars or sugar substitutes are monosaccharides (e.g. fructose, glucose, dextrose and galactose), disaccharides (e.g. sucrose, lactose and maltose), oligosaccharides (e.g. oligofructose, maltodextrin, raffinose and stachyose), polysaccharides, agave nectar, honey, sucralose, Stevia leaf extract, acesulfame potassium (Ace-K), advanteme, neotame, sucralose and sugar alcohols (e.g. sorbitol, xylitol and mannitol).

In particular embodiments, the sugar or sugar substitute may be present in powdered form or as a syrup.

In particular embodiments, the sugar or sugar substitute may be a combination of dextrose and sucrose. The sucrose may be sucrose from sugar beet or sugar cane. The term “leavening agent” as used herein refers to one or more substances used in a dough or a batter that causes the lightening and the softening of the finished baked product. Formation of carbon dioxide is induced by chemical agents reacting with moisture, heat, acidity, or other triggers. The leavening agent in the batter of the present invention may be any suitable leavening agent suitable for preparing cakes. The leavening agents as referred to herein are chemical compounds such as baking powder. Baking powder typically comprises a carbon dioxide carrier (typically a salt of bicarbonate) and a leavening acid (typically a low molecular weight organic acid). Generally recognized leavening agents may include monocalcium phosphate (Ca(H₂PO₄)₂), sodium aluminium sulphate (NaAl(SO₄)₂.12H₂O), disodium pyrophosphate (Na₂H₂P₂O₇), and sodium aluminium phosphate (NaH₁₄Al₃(PO₄)₈.4H₂O and/or Na₃H₁₅Al₂(PO₄)₈).

An alternative or supplement to leavening agents is the mechanical leavening of the batter during which air is incorporated into the batter using mechanical means.

In particular embodiments, the cake batter may comprise the chlorinated flour replacer as described herein (comprising the flour improver as described herein and non-chlorinated flour), fat, eggs or egg products, sugar or sugar substitutes, leavening agent and water; wherein the ratio (w/w) of liquid to flour is between 1 and 3.

The liquid as referred to in the phrase “the ratio (w/w) of liquid to flour is between 1 and 3” refers to the liquid content of a cake batter, i.e. the total amount of water brought into the batter. The water may be added in the form of water, liquid egg and/or milk. The flour as referred to in the phrase “the ratio (w/w) of liquid to flour is between 1 and 3” refers to all flour present in the cake batter. Accordingly, the flour refers at least to the non-chlorinated wheat flour and the non-wheat flour.

A cake batter may comprise for example the following ingredients, typically in the following amounts (in % by weight of the batter):
between 2% and 35% (w/w), such as between 3% and 25% or between 4% and 10% (w/w), of the chlorinated flour replacer as described herein;
between 2% and 35% (w/w) of fat;
between 5 and 40% (w/w) of eggs or egg products;
between 10% and 40% (w/w) of sugar or sugar substitutes;
between 0% and 2.5% of leavening agent; and
water up to 100%.

A cake batter may also comprise for example the following ingredients, typically in the following amounts (in % by weight of the batter):
between 0.35% and 17.5% (w/w) of the flour improver as described herein;
between 2.5% and 32.6% (w/w) of non-chlorinated wheat flour;
between 2% and 35% (w/w) of fat;
between 5% and 40% (w/w) of eggs or egg products;
between 10% and 40% (w/w) of sugar or sugar substitutes;
between 0% and 2.5% (w/w) of leavening agent; and
water up to 100%.

In particular embodiments, the ratio (w/w) of sugar (or sugar substitutes) to flour of the cake batter may be between 0.7 and 3.0. The flour as referred to in the phrase “the ratio (w/w) of sugar (or sugar substitutes) to flour is between 0.7 and 3.0” refers to all flour present in the cake batter. Accordingly, the flour refers at least to the non-chlorinated wheat flour and the non-wheat flour.

In particular embodiments, the cake batter may further comprise one or more emulsifiers.

The term “emulsifier” as used herein refers to substances that are used in cake recipes to emulsify the lipid components (oil, shortening, margarine) into the water-phase of the cake batter, to facilitate and/or increase aeration of the batter during mixing and/or for the stabilization and/or the retention of air cells during baking. Non-limiting examples of emulsifiers typically used in cakes are mono- and diglycerides of fatty acids, lactic acid esters of mono- and diglycerides of fatty acids, acetic or lactic acid esters of mono- and diglycerides of fatty acids, diacetyl tartaric acid esters of mono- and diglycerides, polyglycerol monoesters of fatty acids, propylene glycol esters of fatty acid, sodium stearoyl lactylate, polysorbates, sucrose esters of fatty acids and lecithin (canola, soy, sunflower).

The cake batter may further comprise one or more aroma components, flavour components, hydrocolloids (e.g. locust bean gum, guar gum, tara gum, xanthan gum, carrageenan, acacia gum, cellulose, modified cellulose and pectin), reducing agents (e.g. cysteine or glutathione), oxidants, yeast extract, enzyme active soy flour, starches (e.g. native, chemically and/or physically modified), cocoa powder, chocolate, colouring agents, and/or enzymes. The skilled artisan knows how to combine these ingredients to obtain the desired type of cake product.

In particular embodiments, the enzyme may be one or more enzymes selected from the group consisting of amylase, xylanase, lipase, phospholipase, transglutaminase, glucose oxidase, carbohydrate oxidase, hexose oxidase and lipoxygenase.

The present invention also provides cake mixes and cake premixes comprising the flour improver or the chlorinated flour replacer as described herein. Preferably, said cake mixes and cake premixes are suitable to prepare the cake batter and/or the cake product as described herein. On the one hand, a cake mix typically comprises all dry ingredients of the cake batter as described herein (i.e. all ingredients of the cake batter as described herein with the exception of water, milk and/or liquid eggs). The skilled person will understand that the addition of liquid (e.g. water, milk and/or liquid eggs) to the cake mix may allow obtaining a cake batter as described herein. On the other hand, a cake premix typically comprises a cake mix where all or part of the flour and/or all or part of the sugar has been removed. Accordingly, the skilled person will understand that the addition of liquid (e.g. water, milk and/or liquid eggs), flour and/or sugar to the cake premix may allow obtaining a cake batter as described herein. The skilled person will also understand that the milk and/or the eggs may be present in the cake mix or in the cake premix under powdered form.

A further aspect provides a cake mix comprising the flour improver as described herein; and optionally non-chlorinated wheat flour; fat; dehydrated eggs or egg products; sugar or sugar substitutes; leavening agent, and/or emulsifier(s).

Alternatively, a further aspect provides a cake premix comprising the chlorinated flour replacer as described herein; and optionally fat; dehydrated eggs or egg products; sugar or sugar substitutes; leavening agent, and/or emulsifier(s).

Accordingly further aspect provides a cake premix comprising the flour improver as described herein; and optionally non-chlorinated wheat flour; fat; dehydrated eggs or egg products; leavening agent, and/or emulsifier(s).

Alternatively, a further aspect provides a cake premix comprising the chlorinated flour replacer as described herein; and optionally fat; dehydrated eggs or egg products, leavening agent, and/or emulsifier(s). Alternatively, a further aspect provides the use of the flour improver or the chlorinated flour replacer as described herein in a cake mix or a cake premix.

In particular embodiments, the cake mix or cake premix may further comprise one or more aroma components, flavour components, hydrocolloids (e.g. locust bean gum, guar gum, tara gum, xanthan gum, carrageenan, acacia gum, cellulose, modified cellulose and pectin), reducing agents (e.g. cysteine or glutathione), oxidants, yeast extract, enzyme active soy flour, starches (e.g. native, chemically and/or physically modified), cocoa powder, chocolate, colouring agents, milk powder, and/or enzymes.

As described earlier, the inventors have surprisingly found that the new ingredient combination allowed preparing wheat flour-based high ratio cakes without using chlorinated wheat flour and/or heat-treated flour that have textural properties greater than those of wheat flour-based high ratio cakes made with non-treated flour in absence of the new ingredient mixture. Moreover, the new ingredient combination (i.e. specific amounts of non-wheat flour, protein and calcium 2+ ions) allowed preparing wheat flour-based high ratio cakes without using chlorinated wheat flour and/or heat-treated flour that have textural properties comparable to those of wheat flour-based high ratio cakes made conventionally with chlorinated flour and/or heat-treated flour.

In view of the above, a further aspect provides a cake product comprising the flour improver, the chlorinated flour replacer, the cake batter, the cake mix or the cake premix as described herein.

A further aspect provides the use of the flour improver or the chlorinated flour replacer, or the cake batter as described herein as an ingredient in the preparation of a cake product, preferably a wheat flour-based high ratio cake, preferably wherein the flour improver or the chlorinated flour replacer is used as part of a cake mix or a cake premix. Alternatively, a further aspect provides a cake product prepared from the cake batter as described herein.

In particular embodiments, the cake product may be a baked cake product.

In particular embodiments, the cake product may be a cake product selected from the group consisting of cream cake, pound cake, sponge cake, muffins, cake donuts, loaf cream and pound cakes, cup cream and pound cakes, and brownies.

The cake product can be defined by several texture parameters such as hardness, resilience, springiness, cohesiveness, gumminess and chewiness of the cake product.

The texture parameters may be evaluated by performing a Texture Profile Analysis (TPA) on a cake crumb sample obtained from the cake product or the whole (i.e. entire) cake product. The TPA may be performed with any system known by the skilled person to perform a TPA. For example, such a system may be a Texture Analyser (e.g. TAXT2i, Stable Micro Systems).

More particularly, the texture parameters such as hardness, resilience, springiness, cohesiveness, gumminess and chewiness of the cake product can be calculated from the force-time curve registered when performing a TPA on a cake sample using a Texture Analyser. In TPA, two consecutive deformations with a short waiting time in between the deformations are applied on a cake crumb sample and the force registered by the load cell of the texture analyser is measured as a function of time. For example, two consecutive deformations of a cylindrical cake crumb sample (e.g. with a diameter of 45 mm and a height of 40 mm) with a cylindrical probe (e.g. with a diameter of 100 mm) with a maximum deformation of 50% of the initial height of the product may be performed at a deformation speed of 2 mm/s and a waiting time between the two consecutive deformations of 3s. The force needed to deform the sample may be recorded as a function of time (i.e. force-time curve).

A value of 100 may be set for the respective texture parameters of a cake crumb sample that is used as reference sample in a given test (e.g. a cake crumb sample of a cake product prepared from cake batter comprising chlorinated flour instead of the chlorinated flour replacer as described herein). The parameter values of cake crumb samples different from said reference sample may be expressed relative to this reference sample. The term “hardness” as used herein refers to the maximal force needed to apply a defined deformation (e.g. a fixed deformation of 50% of the initial height of the cake crumb sample or the whole cake product) to a cake crumb sample of the cake product or the whole cake product. The term “hardness” may also refer to the sense related to the force required to compress the cake crumb sample or the whole cake product.

The term “resilience” as used herein refers to the speed (and degree) at which a cake crumb sample of the cake product or the whole cake product returns to its original shape after a certain deformation. It is a measure for how well a product “fights to regain its original height” after a deformation has been applied. Based on TPA method as described elsewhere herein, the resilience may be calculated as the ratio (in %) between the surface under the first deformation curve when the probe is moving upwards to the surface under the first deformation curve when the probe is moving downwards.

The term “springiness” as used herein refers to an expression of how well a cake product physically springs back after it has been deformed during the first compression of the TPA method as described elsewhere herein and has been allowed to wait for the target wait time between deformations. The springiness may be calculated as the height (in %) of the cake crumb sample after the first deformation and 3 sec of rest compared to the initial height of the cake crumb sample.

The term “cohesiveness” as used herein refers to the degree to which the cake crumb of the cake product holds together when rubbing or folding. Based on the TPA method as described elsewhere herein, the cohesiveness may be calculated as the ratio (expressed in %) between the surface under the second deformation curve (i.e. downwards and upwards) and the ratio under the first deformation curve (i.e. downwards and upwards).

The term “gumminess” as used herein refers to the energy required to disintegrate the cake product ready for swallowing and/or the denseness that persists throughout mastication of the food and is measured. Based on the TPA method as described elsewhere herein, the gumminess may be calculated as the mathematical product of hardness and cohesiveness.

The term “chewiness” as used herein refers to the number of chews to masticate a sample to a consistency ready for swallowing and/or the energy to disintegrate a solid food to a state ready for swallowing. Based on the TPA method as described elsewhere herein, the chewiness may be calculated as the mathematical product of hardness, cohesiveness and springiness.

Alternatively, certain cake texture parameters may also be evaluated by performing a sensorial analysis using a panel of cake experts. The cake experts are cake consumers that have been trained to describe and score the different cake texture properties that describe cake freshness: softness (i.e. opposite of hardness), moistness and cohesiveness, all individually and independently. The cake experts use a score card with a scale with scores between 1 and 9 for each parameter. For softness a score of 1 indicates an extremely hard cake, difficult to bite, and a score of 9 indicates an extremely soft cake, with very much less force needed to bite the cake crumb. For moistness, a score of 1 indicates an extremely dry cake crumb and a score of 9 indicates an extremely moist cake. For cohesiveness a score of 1 indicates a very crumbly cake and a score of 9 indicates a very cohesive cake that remains in one piece. Panel members receive a reference cake product with a fixed score for the freshness parameter(s) that have to be evaluated and are asked to score the test cake products relatively to the reference cake product. Sensorial analyses as described above are calibrated and a value difference of 0.5 is considered as significant.

The texture parameters of cakes may be further evaluated by a panel of persons not trained to sensory evaluation. Typically a group of lambda consumers are asked to compare two or more samples of cake and to either indicate which one is the more soft, moist and/or cohesive or either to rank them on a scale from the less hard/moist/cohesive to the more hard/moist/cohesive.

In particular embodiments, the cake product comprises one or more, preferably all, of the following parameters:
a resilience that is at least 20% higher, preferably at least 30% higher, more preferably at least 40% higher, than the resilience of a reference cake product, wherein said reference cake product is a cake product prepared using untreated wheat flour instead of the chlorinated flour replacer as described herein; and
a chewiness that is at least 30% higher, preferably at least 40% higher, than the chewiness of a reference cake product, preferably wherein said reference cake product is a cake product prepared using untreated wheat flour instead of the chlorinated flour replacer as described herein.

A further aspect provides the use of the flour improver or the chlorinated flour replacer as described herein for improving the textural properties (e.g. harness, resilience, springiness and/or chewiness) of wheat flour-based high ratio cakes, preferably wherein said high ratio cakes are prepared from a cake batter having a ratio (w/w) of liquid to flour of between 1 and 3 and/or a ratio (w/w) of sugar to flour between 0.7 and 3.0.

In particular embodiments, said improved textural properties of wheat flour-based high ratio cakes are an, increased resilience and/or increased chewiness compared to the resilience and/or chewiness of a reference wheat flour-based high ratio cake, wherein said reference high ratio cake is a high ratio cake prepared using untreated wheat flour instead of the chlorinated flour replacer as described herein.

A further aspect provides the use of the flour improver or the chlorinated flour replacer according as described herein for one or more of the following:
increasing and/or improving the resilience of a wheat flour-based high ratio cake by at least 20%, preferably at least 30%, more preferably at least 40%, compared to the resilience of a reference wheat flour-based high ratio cake, wherein said reference high ratio cake is a high ratio cake prepared using untreated wheat flour instead of the chlorinated flour replacer as described herein; and
increasing and/or improving the chewiness of a wheat flour-based high ratio cake by at least 30%, preferably at least 40%, compared to the chewiness of a reference wheat flour-based high ratio cake, preferably wherein said reference high ratio cake is a high ratio cake prepared using untreated wheat flour instead of the chlorinated flour replacer as described herein.

A further aspect provides a method for preparing the flour improver as described herein, comprising the step of preparing a mixture of at least (in % by weight of the flour improver):
between 10% and 97.5% (w/w) of non-wheat flour, wherein said non-wheat flour is one or more non-wheat flours selected from the group consisting of rice flour, oat flour, quinoa flour and buckwheat flour;
between 2% and 20% (w/w) of a gel-forming protein in addition to protein present in the non-chlorinated wheat flour and the non-wheat flour; and
between 0.5 and 3% (w/w) of calcium 2+ ions, thereby obtaining the flour improver as described herein.

In particular embodiments, the method for preparing the flour improver as described herein comprises the step of preparing a mixture of at least (in % by weight of the flour improver):
between 20% and 95% (w/w), between 30% and 90% (w/w), or between 80% and 90% (w/w), preferably between 30% and 90% % (w/w), of non-wheat flour, wherein said non-wheat flour is one or more non-wheat flours selected from the group consisting of rice flour, oat flour, quinoa flour and buckwheat flour;
between 4% and 18% (w/w), or between 6% and 15% (w/w), or between 10% and 15% (w/w), preferably between 6% and 15% (w/w), of a gel-forming protein in addition to protein present in the non-chlorinated wheat flour and the non-wheat flour; and
between 0.7% and 2% (w/w), or between 0.9% and 1.6% (w/w), preferably between 0.9% and 1.3% (w/w), of calcium 2+ ions, thereby obtaining the flour improver as described herein.

In particular embodiments, the order in which the ingredients of the flour improver as described herein are combined into a mixture may happen without method (i.e. at random).

A further aspect provides a method for preparing a chlorinated flour replacer as described herein, comprising the step of preparing a mixture of at least (in % by weight of the chlorinated flour replacer):
between 40% and 90% (w/w), between 45% and 90%, between 50% and 80% (w/w), or between 70% and 90% (w/w), preferably between 70% and 80% (w/w), of non-chlorinated wheat flour, and
between 10% and 60% (w/w), between 10% and 55%, between 20% and 50% (w/w), or between 20% and 30% (w/w), preferably between 20% and 30% (w/w), of the flour improver as described herein;
thereby obtaining the chlorinated flour replacer as described herein.

Alternatively, a further aspect provides a method for preparing a chlorinated flour replacer as described herein, comprising the step of preparing a mixture of at least (in % by weight of the chlorinated flour replacer):
between 40% and 88.75% (w/w), preferably between 70% and 80% (w/w) of non-chlorinated wheat flour,
between 10% and 58% (w/w), preferably between 10% and 25% (w/w), of non-wheat flour wherein said non-wheat flour is one or more non-wheat flours selected from the group consisting of rice flour, oat flour, quinoa flour and buckwheat flour;
between 1% and 10% (w/w), preferably between 2% and 4% (w/w), of a gel-forming protein in addition to protein present in the non-chlorinated wheat flour and the non-wheat flour; and
between 0.25% and 1% (w/w), preferably between 0.25% and 0.8% (w/w), of calcium 2+ ions, thereby obtaining the chlorinated flour replacer as described herein.

In particular embodiments, the order in which the ingredients of the chlorinated flour replacer as described herein are combined into a mixture may happen without method (i.e. at random).

The skilled person will understand that the particular embodiments relating to the non-chlorinated wheat flour, the non-wheat flour, the gel-forming protein in addition to protein present in the non-chlorinated wheat flour and the non-wheat flour and the calcium 2+ ions also apply to the cake batter and the method for preparing the chlorinated flour replacer as described herein.

A further aspect provides a method for preparing a cake batter as described herein, comprising the steps of adding a flour improver as described herein to non-chlorinated wheat flour, fat, eggs, sugar, leavening agent and water and ensuring that the ratio (w/w) of liquid to flour is between 1 and 3, and optionally ensuring that the ratio (w/w) of sugar to flour is between 0.7 and 3.0; thereby obtaining the cake batter.

In particular embodiments, the order in which the ingredients of the cake batter as described herein are combined into a mixture may happen without method (i.e. at random).

In a particular embodiment, the method for preparing a cake batter as described herein, comprises the steps of first adding the flour improver to the dry ingredients of the cake batter (e.g. non-chlorinated flour, sugar, powdered eggs and/or leavening agent) thereby obtaining a first mixture and subsequently adding the liquid ingredients of the cake batter (e.g. water and/or liquid fat (e.g. oil)), to said first mixture; and ensuring that the ratio (w/w) of liquid to flour is between 1 and 3, and optionally ensuring that the ratio (w/w) of sugar to flour is between 0.7 and 3.0; thereby obtaining the cake batter.

Alternatively, a further aspect provides a method for preparing a cake batter as described herein, comprising the steps of adding a chlorinated flour replacer as described herein to fat, eggs, sugar, leavening agent and water and ensuring that the ratio (w/w) of liquid to flour is between 1 and 3, and optionally ensuring that the ratio (w/w) of sugar to flour is between 0.7 and 3.0; thereby obtaining the cake batter.

In a particular embodiment, the method for preparing a cake batter as described herein, comprises the steps of first adding the chlorinated flour replacer to the dry ingredients of the cake batter (e.g. sugar, powdered eggs and/or leavening agent) thereby obtaining a first mixture and subsequently adding the liquid ingredients of the cake batter (e.g. water and/or liquid fat (e.g. oil)), to said first mixture; and ensuring that the ratio (w/w) of liquid to flour is between 1 and 3, and optionally ensuring that the ratio (w/w) of sugar to flour is between 0.7 and 3.0; thereby obtaining the cake batter.

A further aspect provides a method for preparing a cake product as described herein, comprising the steps of providing a flour improver or a chlorinated flour replacer as described herein; adding the flour improver or the chlorinated flour replacer to a dough or a batter; and baking the dough or the batter, thereby obtaining the cake product.

### EXAMPLES

### Example 1: Comparison of High Ratio Cakes Prepared Using the Chlorinated Flour Replacer as Described Herein and Cakes Prepared Using Treated Flour or Untreated Flour, in Absence of the Chlorinated Flour Replacer as Described Herein

Table 1 describes the compositions of the different cake batters used in Example 1. In a first phase all dry components as listed in Table 1 are mixed: sugar, shortening and mono- and diglycerides are mixed in a planetary mixer (Hobart type N50) using a paddle for 5 minutes at speed 1 and 10 minutes at speed 2. Flour is added and the mixture is mixed for 5 minutes at speed 1. All other dry ingredients are added and the mixture is mixed for 10 minutes at speed 1.

In a second phase the batter is prepared in three steps. Step 1: 250 ml of water is added and mixed for 1 minute at speed 1. Step 2: 250 ml of water is added and mixed for 1 minute at speed 1. Step 3: 200 ml of water and 116 ml of oil is added and mixed for 1 minute at speed 1.

In a third phase the batter is baked. Batter, 425 g, is deposited in a round metal pan (diameter=8 inch) and is baked in a deck oven for 30 minutes at 180° C.

After 2 hours of cooling cakes are packed in plastic bags.

TABLE 1
cake batter compositions (expressed as % by weight of the batter)

| | CL1 | HT1 | REF1 | RF1A |
|---|---|---|---|---|
| Bleached flour | 23.9 | 0.0 | 0.0 | 0.0 |
| Heat treated soft wheat flour | 0.0 | 23.9 | 0.0 | 0.0 |
| Untreated soft wheat flour (ADM. USA) | 0.0 | 0.0 | 23.9 | 17.7 |
| Rice Flour (Remyflo R7 90 T CP, Beneo) | 0.0 | 0.0 | 0.0 | 5.3 |
| Whey protein (Nutrilac, Arla)* | 0.0 | 0.0 | 0.0 | 0.7 |
| CaCl₂•2H₂O | 0.0 | 0.0 | 0.0 | 0.2 |
| Sucrose | 21.2 | 21.2 | 21.2 | 21.2 |
| Shortening | 1.2 | 1.2 | 1.2 | 1.2 |
| Mono-and diglycerides of fatty acids | 2.0 | 2.0 | 2.0 | 2.0 |
| (Puratos) | | | | |
| Egg White Powder | 2.0 | 2.0 | 2.0 | 2.0 |
| Egg Yolk Powder | 1.1 | 1.1 | 1.1 | 1.1 |
| Dextrose Monohydrate | 1.1 | 1.1 | 1.1 | 1.1 |
| Skimmed Milk Powder | 1.4 | 1.4 | 1.4 | 1.4 |
| Salt | 0.5 | 0.5 | 0.5 | 0.5 |
| Baking powder | 1.4 | 1.4 | 1.4 | 1.4 |
| Hydrocolloid | 0.1 | 0.1 | 0.1 | 0.1 |
| Oil | 37.4 | 37.4 | 37.4 | 37.4 |
| Water | 6.5 | 6.5 | 6.5 | 6.5 |

*a protein solution comprising functionalized whey proteins, contains about 76% proteins;

Cake texture parameters are measured 24 hours after baking.

The hardness (as opposite of softness), the cohesiveness, the resilience, the springiness, the stickiness, the gumminess and the chewiness of the cake crumb are evaluated by performing a Texture Profile Analysis (TPA) on cake crumb samples with a Texture Analyser (TAXT2, Stable Micro Systems, UK). Two consecutive deformations of a cylindrical cake crumb sample (diameter=45 mm, height 40 mm) with a cylindrical probe (diameter=100 mm) with a maximum deformation of 50% of the initial height of the product are performed at a deformation speed of 2 mm/sec and a waiting time between the two consecutive deformations of 3 sec. Force, measured by the load cell of the Texture Analyser, is recorded as a function of time.

The hardness is the maximum force needed to apply a fixed deformation of 50% of the initial height of the cake sample.

The cohesiveness is calculated as the ratio (expressed in percent) between the surface under the second deformation curve (downwards+upwards) and the ratio under the first deformation curve (downwards+upwards).

The stickiness is the negative force needed to loosen the probe from the cake surface after the deformation.

The resilience is calculated as the ratio (in %) between the surface under the first deformation curve when the probe is moving upwards to the surface under the first deformation curve when the probe is moving downwards.

The springiness is calculated as the height (in %) of the cake cylinder after the first deformation and 3 sec of rest compared to the initial height of the cake cylinder. The chewiness is calculated as the mathematical product of the hardness, the cohesiveness and the springiness.

TABLE 2
cake texture properties measured with the Texture Analyser
(relative value to the results obtained for CL1 that have been set to 100)

| | Hardness | Resilience | | Chewiness |
|---|---|---|---|---|
| | (g) | (%) | Springiness | (g) |
| CL1 | 100 | 100 | 100 | 100 |
| (comparative example) | | | | |
| RF1 | 60 | 65 | 94 | 54 |
| (comparative example) | | | | |
| HT1 | 78 | 71 | 99 | 68 |
| (comparative example) | | | | |
| RF1A (*) | 83 | 82 | 96 | 80 |

(*) cake batter comprising the flour improver as described herein

The results show that a cake batter comprising the flour improver (or the chlorinated flour replacer) according to the invention allows improving the texture properties of a high ratio cake made with untreated flour to an acceptable level of quality. More particularly, the cake batter composition comprising the flour improver (or the chlorinated flour replacer) according to the invention allows obtaining high ratio cakes with a level of hardness, resilience, springiness and chewiness which is close to the level of hardness, resilience, springiness and chewiness of cake made with chlorinated four.

### Example 2: The Type of Non-Chlorinated Wheat Flour Used in the Chlorinated Flour Replacer as Described Herein is Variable

Table 3 describes the compositions of the chlorinated flour replacer as described herein used in the different cake batters whose compositions are depicted in Table 4. High ratio cakes were prepared as in Example 1.

TABLE 3
Compositions of the chlorinated flour replacer as used in Example 2
(expressed as % by weight of the chlorinated flour replacer)-

| % (w/w) | A | B | C | D |
|---|---|---|---|---|
| Untreated soft wheat flour (ADM. USA) | 74 | 0 | 0 | 0 |
| European pastry flour | 0 | 74 | 0 | 0 |
| European bread flour | 0 | 0 | 74 | 0 |
| Durum flour | 0 | 0 | 0 | 74 |
| Rice Flour (Remyflo R7 90 T CP, Beneo) | 22 | 22 | 22 | 22 |
| Whey protein (Nutrilac, Arla)* | 3 | 3 | 3 | 3 |
| CaCl₂•2H₂O | 1 | 1 | 1 | 1 |

*contains about 76% of proteins

TABLE 4
cake batter compositions (expressed as % by weight of the batter)

| | REF2 | RF2A | RF2B | RF2C | RF21D |
|---|---|---|---|---|---|
| Untreated soft wheat | 23.9 | 0.0 | 0.0 | 0.0 | 0.0 |
| flour (ADM. USA) | | | | | |
| Chlorinated flour | | 23.9 | | | |
| replacer A of table 3 | | | | | |
| Chlorinated flour | | | 23.9 | | |
| replacer B of Table 3 | | | | | |
| Chlorinated flour | | | | 23.9 | |
| replacer C of Table 3 | | | | | |
| Chlorinated flour | | | | | 23.9 |
| replacer D of Table 3 | | | | | |
| Sucrose | 21.1 | 21.1 | 21.1 | 21.1 | 21.1 |
| Shortening | 1.2 | 1.2 | 1.2 | 1.2 | 1.2 |
| Mono-and diglycerides | 2.0 | 2.0 | 2.0 | 2.0 | 2.0 |
| of fatty acids (Puratos) | | | | | |
| Egg White Powder | 1.9 | 1.9 | 1.9 | 1.9 | 1.9 |
| Egg Yolk Powder | 1.1 | 1.1 | 1.1 | 1.1 | 1.1 |
| Dextrose Monohydrate | 1.4 | 1.4 | 1.4 | 1.4 | 1.4 |
| Skimmed Milk Powder | 1.1 | 1.1 | 1.1 | 1.1 | 1.1 |
| Salt | 0.5 | 0.5 | 0.5 | 0.5 | 0.5 |
| Baking powder | 1.4 | 1.4 | 1.4 | 1.4 | 1.4 |
| Hydrocolloid | 0.1 | 0.1 | 0.1 | 0.1 | 0.1 |
| Aroma | 0.6 | 0.6 | 0.6 | 0.6 | 0.6 |
| Oil | 6.5 | 6.5 | 6.5 | 6.5 | 6.5 |
| Water | 37.2 | 37.2 | 37.2 | 37.2 | 37.2 |

Table 5 presents the texture properties of the cakes.

TABLE 5
cake texture properties measured with the Texture Analyser
(relative value to the results obtained for REF2 that have been set to 100)

| | Hardness | Resilience | | Chewiness |
|---|---|---|---|---|
| | (g) | (%) | Springiness | (g) |
| REF2 | 100 | 100 | 100 | 100 |
| RF2A (cake batter | 134 | 127 | 102 | 142 |
| comprising chlorinated | | | | |
| flour replacer A) | | | | |
| RF2B (cake batter | 132 | 126 | 103 | 141 |
| comprising chlorinated | | | | |
| flour replacer B) | | | | |
| RF2C (cake batter | 135 | 128 | 103 | 143 |
| comprising chlorinated | | | | |
| flour replacer C) | | | | |
| RF2D (cake batter | 187 | 130 | 101 | 188 |
| comprising chlorinated | | | | |
| flour replacer D) | | | | |

The results show that a combination of rice flour, whey protein and calcium in the chlorinated flour replacer as described herein allows obtaining high ratio cakes with improved textural properties compared to high ratio cakes obtained with regular, untreated wheat flour, in absence of the chlorinated flour replacer as described herein. More particularly, the chlorinated flour replacer as described herein allows increasing the resilience of the cakes by at least 25% and/or the chewiness of the cakes by at least 40%.

### Example 3: Synergistic Effect of the Ingredients of the Chlorinated Flour Replacer

High ratio cakes are prepared using the flours of Table 6 and the batter compositions of Table 7. Cakes are prepared and cake texture properties are measured as described in Example 1.

TABLE 6
Compositions of the chlorinated flour replacer and
control flours as used in Example 3
(expressed as % by weight of the chlorinated
flour replacer or the control flour)

| % (w/w) | E | F | G | H |
|---|---|---|---|---|
| Untreated soft wheat flour (ADM, USA) | 98 | 97 | 78 | 73 |
| Rice Flour (Remyflo R7 90 T CP, Beneo) | 0 | 0 | 22 | 22 |
| Egg white protein* | 0 | 3 | 0 | 3 |
| CaCl₂•2H₂O | 2 | 0 | 0 | 2 |

*contains 80% of proteins

TABLE 7
cake batter compositions (expressed as % by weight of the batter).

| | REF3 | CA3 | EW3 | RF3 | COMBI3 |
|---|---|---|---|---|---|
| Untreated soft wheat | 24.1 | 0 | 0 | 0 | 0 |
| flour (ADM, USA) | | | | | |
| Flour E of table 6 | | 24.1 | | | |
| Flour F of Table 6 | | | 24.1 | | |
| Flour G of Table 6 | | | | 24.1 | |
| Chlorinated flour | | | | | 24.1 |
| replacer H of Table 6 | | | | | |
| Shortening | 1.2 | 1.2 | 1.2 | 1.2 | 1.2 |
| Mono-and diglycerides | 1.7 | 1.7 | 1.7 | 1.7 | 1.7 |
| of fatty acids (Puratos) | | | | | |
| Sucrose | 21.2 | 21.2 | 21.2 | 21.2 | 21.2 |
| Egg White Powder | 2.0 | 2.0 | 2.0 | 2.0 | 2.0 |
| EggYolk Powder | 1.1 | 1.1 | 1.1 | 1.1 | 1.1 |
| Dextrose Monohydrate | 1.4 | 1.4 | 1.4 | 1.4 | 1.4 |
| Skimmed Milk Powder | 1.1 | 1.1 | 1.1 | 1.1 | 1.1 |
| Salt | 0.5 | 0.5 | 0.5 | 0.5 | 0.5 |
| Baking powder | 1.4 | 1.4 | 1.4 | 1.4 | 1.4 |
| Hydrocolloid | 0.1 | 0.1 | 0.1 | 0.1 | 0.1 |
| Oil | 6.7 | 6.7 | 6.7 | 6.7 | 6.7 |
| Water | 37.5 | 37.5 | 37.5 | 37.5 | 37.5 |

The cake texture parameters are evaluated 24 hours after baking as described in Example 1. The results are presented in Table 8.

TABLE 8
cake texture properties measured with the Texture Analyser
(relative value to the results obtained for REF3 that have
been set to 100)

| | Hardness | Resilience | Chewiness |
|---|---|---|---|
| | (g) | (%) | (g) |
| REF3 | 100 | 100 | 100 |
| CA3 | 116 | 107 | 113 |
| EW3 | 109 | 112 | 117 |
| RF3 | 99 | 118 | 105 |
| COMBI3 | 141 | 142 | 159 |

A synergistic effect on the hardness, the resilience and/or the chewiness of high ratio cakes is measured on partial replacement of untreated wheat flour by the combination of rice flour, CaCl₂ and egg protein (e.g. by use of the chlorinated flour replacer H).

### Example 4: The Type of Gel-Forming Protein and/or Protein Source Used in the Chlorinated Flour Replacer as Described Herein is Variable

High ratio cakes are prepared using the chlorinated flour replacer of Table 9 and the batter composition of Table 10. Cakes are prepared and cake texture properties are measured as described in example 1.

TABLE 9
composition of the chlorinated flour replacer
used in Example 4 (expressed as % by
weight of the chlorinated flour replacer)

| | I |
|---|---|
| Untreated soft wheat flour (ADM, USA) | 73 |
| Rice Flour (Remyflo R7 90 T CP, | 22 |
| Beneo) | |
| Whey protein (Nutrilac, Arla) | 3 |
| CaCl₂•2H₂O | 2 |

TABLE 10
cake batter compositions (expressed as % by weight of the batter).

| | REF4 | COMBI4 |
|---|---|---|
| Untreated soft wheat flour (ADM, USA) | 24.1 | |
| Chlorinated flour replacer I of table 9 | | 24.1 |
| Shortening | 1.2 | 1.2 |
| Mono-and diglycerides of fatty acids (Puratos) | 1.7 | 1.7 |
| Sucrose | 21.2 | 21.2 |
| Egg White Powder | 2.0 | 2.0 |
| Egg Yolk Powder | 1.1 | 1.1 |
| Dextrose Monohydrate | 1.4 | 1.4 |
| Skimmed Milk Powder | 1.1 | 1.1 |
| Salt | 0.5 | 0.5 |
| Baking powder | 1.4 | 1.4 |
| Hydrocolloid | 0.1 | 0.1 |
| Oil | 6.7 | 6.7 |
| Water | 37.5 | 37.5 |

The cake texture parameters are evaluated 24 hours after baking as described in Example 1. The results are presented in Table 11.

TABLE 11
Cake texture properties measured with the Texture Analyser
(relative value to the results obtained for REF4 that have been set to 100)

| | Hardness | Resilience | Stickiness | Chewiness |
|---|---|---|---|---|
| | (g) | (%) | (g) | (g) |
| REF4 | 100 | 100 | 100 | 100 |
| COMBI4 | 160 | 133 | 27 | 170 |

The use of an alternative protein source, namely whey protein (i.e. whey protein which has been modified to have gel-forming properties) instead of egg white protein (see Example 3, Table 6), also allows the improvement of the cake properties, such as resilience and/or chewiness, when the protein is combined with a calcium (2+) source and rice flour in cake prepared with untreated flour.

### Example 5: The Type of Calcium Source Used in the Chlorinated Flour Replacer as Described Herein is Variable

High ratio cakes are prepared using the flours of Table 12 and the batter compositions of Table 13. Cakes are prepared and cake texture properties are measured as described in Example 1.

TABLE 12
Compositions of the chlorinated flour replacer and control
flours as used in Example 5 (expressed as % by weight of
the chlorinated flour replacer or the control flour)

| | J | K | L | M |
|---|---|---|---|---|
| Untreated soft wheat flour (ADM, USA) | 98 | 97 | 78 | 73 |
| Rice Flour (Remyflo R7 90 T CP, Beneo) | 0 | 0 | 22 | 22 |
| Whey protein (Nutrilac, Arla) | 0 | 3 | 0 | 3 |
| Ca-acetate | 2 | 0 | 0 | 2 |

TABLE 13
cake batter compositions (expressed as % by weight of the batter)

| | REF5 | CA5 | WP5 | RF5 | COMBI5 |
|---|---|---|---|---|---|
| Untreated soft wheat flour | 24.1 | | | | |
| (ADM, USA) | | | | | |
| Flour J of table 12 | | 24.1 | | | |
| Flour k of table 12 | | | 24.1 | | |
| Flour L of table 12 | | | | 24.1 | |
| Chlorinated flour replacer M of | | | | | 24.1 |
| table 12 | | | | | |
| Shortening | 1.2 | 1.2 | 1.2 | 1.2 | 1.2 |
| Mono- and diglycerides of fatty | 1.7 | 1.7 | 1.7 | 1.7 | 1.7 |
| acids (Puratos) | | | | | |
| Sucrose | 21.2 | 21.2 | 21.2 | 21.2 | 21.2 |
| Egg White Powder | 2.0 | 2.0 | 2.0 | 2.0 | 2.0 |
| Egg Yolk Powder | 1.1 | 1.1 | 1.1 | 1.1 | 1.1 |
| Dextrose Monohydrate | 1.4 | 1.4 | 1.4 | 1.4 | 1.4 |
| Skimmed Milk Powder | 1.1 | 1.1 | 1.1 | 1.1 | 1.1 |
| Salt | 0.5 | 0.5 | 0.5 | 0.5 | 0.5 |
| Baking powder | 1.4 | 1.4 | 1.4 | 1.4 | 1.4 |
| Hydrocolloid | 0.1 | 0.1 | 0.1 | 0.1 | 0.1 |
| Oil | 6.7 | 6.7 | 6.7 | 6.7 | 6.7 |
| Water | 37.5 | 37.5 | 37.5 | 37.5 | 37.5 |

The cake texture parameters are evaluated 24 hours after baking as described in Example 1. The results are presented in Table 14.

TABLE 14
cake texture properties measured with the Texture Analyser
(relativev alue to the results obtained for REF5 that have been set to 100)

| | Hardness | Resilience | Chewiness |
|---|---|---|---|
| | (g) | (%) | (g) |
| REF5 | 100 | 100 | 100 |
| CA5 | 126 | 113 | 123 |
| WP5 | 115 | 113 | 123 |
| RF5 | 110 | 124 | 118 |
| COMBI5 | 154 | 140 | 168 |

The use of an alternative calcium source, namely Ca-acetate instead of CaCl₂ (see Example 4, Table 9), also allows obtaining a synergistic effect on the cake resilience and/or chewiness between the 3 ingredients, namely non-wheat flour, calcium 2+ ions and gel-forming protein.

### Example 6: The Amount of Non-Wheat Flour Used in the Chlorinated Flour Replacer as Described Herein can be Varied within a Range of 10% and 58% (w/w) of Non-Wheat Flour (Expressed as % by Weight of the Chlorinated Flour Replacer)

High ratio cakes are prepared using the chlorinated flour replacers of Table 15 and the batter compositions of Table 16. Cakes are prepared and cake texture properties are measured as described in Example 1.

TABLE 15
Compositions of the chlorinated flour replacer as
used in Example 6 (expressed as % by
weight of the chlorinated flour replacer)-

| | N | O | P | Q |
|---|---|---|---|---|
| Untreated soft wheat flour (ADM. USA) | 76 | 67 | 58 | 50 |
| Rice Flour (Remyflo R7 90 T CP, Beneo) | 20 | 29 | 38 | 46 |
| Whey protein (Nutrilac, Arla) | 3 | 3 | 3 | 3 |
| CaCl₂•2H₂O | 1 | 1 | 1 | 1 |

TABLE 16
cake batter compositions (expressed as % by weight of the batter)

| | RF20% | RF29% | RF38% | RF50% |
|---|---|---|---|---|
| Chlorinated flour replacer N | 22.8 | | | |
| of table 15 | | | | |
| Chlorinated flour replacer O | | 22.5 | | |
| of table 15 | | | | |
| Chlorinated flour replacer P | | | 22.1 | |
| of table 15 | | | | |
| Chlorinated flour replacer Q | | | | 21.8 |
| of table 15 | | | | |
| Shortening | 1.2 | 1.2 | 1.2 | 1.2 |
| Mono-and diglycerides of | 2.0 | 2.0 | 2.0 | 2.0 |
| fatty acids (Puratos) | | | | |
| Sucrose | 21.1 | 21.1 | 21.1 | 21.1 |
| Egg White Powder | 1.9 | 1.9 | 1.9 | 1.9 |
| Egg Yolk Powder | 1.1 | 1.1 | 1.1 | 1.1 |
| Dextrose Monohydrate | 1.4 | 1.4 | 1.4 | 1.4 |
| Skimmed Milk Powder | 1.1 | 1.1 | 1.1 | 1.1 |
| Salt | 0.5 | 0.5 | 0.5 | 0.5 |
| Baking powder | 1.1 | 1.1 | 1.1 | 1.1 |
| Hydrocolloid | 0.1 | 0.1 | 0.1 | 0.1 |
| Aroma | 0.6 | 0.6 | 0.6 | 0.6 |
| Vital Wheat Gluten | 0.6 | 1.0 | 1.3 | 1.6 |
| Extendo Y (Puratos, Belgium) | 0.6 | 0.6 | 0.6 | 0.6 |
| Glucose oxidase | 0.3 | 0.3 | 0.3 | 0.3 |
| Oil | 6.5 | 6.5 | 6.5 | 6.5 |
| Water | 37.1 | 37.0 | 37.1 | 37.1 |

The cake texture parameters are evaluated 24 hours after baking as described in Example 1. The results are presented in Table 17.

TABLE 17
cake properties measured with the Texture Analyser (relative value
to the results obtained for RF20% that have been set to 100)

| | Hardness (g) | Resilience (%) | Chewiness (g) |
|---|---|---|---|
| RF20% | 100 | 100 | 100 |
| RF29% | 97 | 106 | 98 |
| RF38% | 103 | 113 | 103 |
| RF50% | 111 | 119 | 114 |

The results shows that an increase of the amount of rice flour in the chlorinated flour replacer causes an increase of the hardness, the chewiness and the gumminess of the cake crumb.

### Example 7: The Type of Rice Flour Used in the Chlorinated Flour Replacer as Described Herein is Variable

High ratio cakes are prepared using the chlorinated flour replacers of Table 18 and the batter compositions of Table 20. The properties of the rice flours used are described in Table 19. Cakes are prepared and cake texture properties are measured as described in Example 1.

TABLE 18
compositions of the chlorinated flour replacer used in Example
7 (expressed as % by weight of the chlorinated flour replacer)

| % (w/w) | R | S | T |
|---|---|---|---|
| Untreated soft wheat flour (ADM, USA) | 74 | 74 | 74 |
| Remyflo R7 90T CP | 22 | 0 | 0 |
| Remyflo R7 200 | 0 | 22 | 0 |
| Remyflo S200 | 0 | 0 | 22 |
| Whey protein (Nutrilac, Arla) | 3 | 3 | 3 |
| CaCl₂•2H₂O | 1 | 1 | 1 |

TABLE 19
properties of the types of rice flours used

| Commercial name | Milling method | Properties |
|---|---|---|
| Remyflo R7 90 | Wet milling | 20-30% amylose, gelatinization |
| T CP | | temperature 70° C. |
| Remyflo R7 200 | Dry milling | 20-30% amylose, gelatinization |
| | | temperature 70° C. |
| Remyflo S200 | Dry milling | Waxy rice, amylose content max 3% |

TABLE 20
cake batter compositions (expressed as % by weight of the batter)

| | RF7A | RF7B | RF7C |
|---|---|---|---|
| Chlorinated flour replacer R of table 18 | 24.5 | | |
| Chlorinated flour replacer S of table 18 | | 24.5 | |
| Chlorinated flour replacer T of table 18 | | | 24.5 |
| Shortening | 1.2 | 1.2 | 1.2 |
| Mono- and diglycerides of fatty acids (Puratos) | 2.0 | 2.0 | 2.0 |
| Sucrose | 21.1 | 21.1 | 21.1 |
| Egg White Powder | 1.9 | 1.9 | 1.9 |
| Egg Yolk Powder | 1.1 | 1.1 | 1.1 |
| Dextrose Monohydrate | 1.4 | 1.4 | 1.4 |
| Skimmed Milk Powder | 1.1 | 1.1 | 1.1 |
| Salt | 0.5 | 0.5 | 0.5 |
| Baking powder | 1.4 | 1.4 | 1.4 |
| Hydrocolloid | 0.1 | 0.1 | 0.1 |
| Oil | 6.5 | 6.5 | 6.5 |
| Water | 37.2 | 37.2 | 37.2 |

The resilience of the cakes is evaluated 24 hours after baking as described in Example 1. The results are presented in Table 21.

TABLE 21
resilience of cake crumb measured with the Texture Analyser (relative
value to the results obtained for RF7A that have been set to 100)

| | Resilience (%) |
|---|---|
| RF7A | 100 |
| RF7B | 93 |
| RF7C | 94 |

These results show that the use of wet milled rice flour as non-wheat flour in the chlorinated flour replacer as described herein gives a better resiliency of the cake crumb than the use of dry milled flour.

### Example 8: The Use of Rice Starch Instead of Rice Flour is Ineffective

High ratio cakes are prepared using the chlorinated flour replacers of Table 22 and the batter compositions of Table 23. Cakes are prepared and cake texture properties are measured as described in Example 1.

TABLE 22
compositions of the chlorinated flour replacer used in Example
8 (expressed as % by weight of the chlorinated flour replacer)

| % (w/w) | U | V (***) | W (***) |
|---|---|---|---|
| Untreated soft wheat flour (ADM, USA) | 74 | 74 | 74 |
| Remyflo R7 90T CP | 22 | 0 | 0 |
| Remy B7* | 0 | 22 | 0 |
| Remy XS** | 0 | 0 | 22 |
| Whey protein (Nutrilac, Arla) | 3 | 3 | 3 |
| CaCl₂•2H₂O | 1 | 1 | 1 |

*Remy B7 is a dry milled rice starch with 20-30% amylose and a gelatinization temperature of 70° C.
**Remy XS is a dry milled waxy rice starch with an amylose content of max 3%
(***) comparative example

TABLE 23
cake batter compositions (expressed as % by weight of the batter)

| | | RF8B | RF8C |
|---|---|---|---|
| | RF8A | (***) | (***) |
| Chlorinated flour replacer U of table 22 | 24.5 | | |
| Chlorinated flour replacer V of table 22 | | 24.5 | |
| Chlorinated flour replacer W of table 22 | | | 24.5 |
| Shortening | 1.2 | 1.2 | 1.2 |
| Mono- and diglycerides of fatty acids (Puratos) | 2.0 | 2.0 | 2.0 |
| Sucrose | 21.1 | 21.1 | 21.1 |
| Egg White Powder | 1.9 | 1.9 | 1.9 |
| Egg Yolk Powder | 1.1 | 1.1 | 1.1 |
| Dextrose Monohydrate | 1.4 | 1.4 | 1.4 |
| Skimmed Milk Powder | 1.1 | 1.1 | 1.1 |
| Salt | 0.5 | 0.5 | 0.5 |
| Baking powder | 1.4 | 1.4 | 1.4 |
| Hydrocolloid | 0.1 | 0.1 | 0.1 |
| Oil | 6.5 | 6.5 | 6.5 |
| Water | 37.2 | 37.2 | 37.2 |

(***) comparative example

The resilience of the cakes is evaluated 24 hours after baking as described in Example 1. The results are presented in Table 24.

TABLE 24
resilience of cake crumb measured with the Texture Analyser (relative
value to the results obtained for RF8A that have been set to 100)

| | Resilience (%) |
|---|---|
| RF8A | 100 |
| RF8B (comparative example) | 85 |
| RF8C (comparative example) | 80 |

These results show that the crumb resilience of high ratio cakes prepared with addition of rice starch is significantly lower than for cakes prepared with addition of rice flour.

### Example 9: The Use of Soy Flour Instead of Non-Wheat Flour (Rice Flour) is Ineffective

High ratio cakes are prepared using the chlorinated flour replacers of Table 25 and the batter compositions of Table 26. Cakes are prepared and cake texture properties are measured as described in Example 1.

TABLE 25
compositions of the chlorinated flour replacer used in Example
7 (expressed as % by weight of the chlorinated flour replacer)

| % (w/w) | X | Y (*) |
|---|---|---|
| Untreated soft wheat flour (ADM, USA) | 74 | 74 |
| Remyflo R7 90T CP | 22 | 0 |
| Defatted Soy Flour | 0 | 22 |
| Whey protein (Nutrilac, Arla) | 3 | 3 |
| CaCl₂•2H₂O | 1 | 1 |

(*) comparative example

TABLE 26
cake batter compositions (expressed as % by weight of the batter)

| | | RF9B |
|---|---|---|
| | | (comparative |
| | RF9A | example) |
| Chlorinated flour replacer X of table 25 | 24.5 | |
| Chlorinated flour replacer Y of table 25 | | 24.5 |
| Shortening | 1.2 | 1.2 |
| Mono- and diglycerides of fatty acids (Puratos) | 2.0 | 2.0 |
| Sucrose | 21.1 | 21.1 |
| Egg White Powder | 1.9 | 1.9 |
| Egg Yolk Powder | 1.1 | 1.1 |
| Dextrose Monohydrate | 1.4 | 1.4 |
| Skimmed Milk Powder | 1.1 | 1.1 |
| Salt | 0.5 | 0.5 |
| Baking powder | 1.4 | 1.4 |
| Hydrocolloid | 0.1 | 0.1 |
| Oil | 6.5 | 6.5 |
| Water | 37.2 | 37.2 |

The resilience of the cakes is evaluated 24 hours after baking as described in Example 1. The results are presented in Table 27.

TABLE 27
resilience of cake crumb measured with the Texture Analyser (relative
value to the results obtained for RF7A that have been set to 100)

| | Resilience (%) |
|---|---|
| RF9A | 100 |
| RF9B (comparative example) | 86 |

These results show that the use of soy flour as non-wheat flour in the chlorinated flour replacer as described herein gives a worse resiliency of the cake crumb than the use of rice flour.

### Example 10: The Use of Non Gelling Proteins is Ineffective

The gelling properties of 4 samples of proteins (whey protein (Nutrilac, Arla); egg white powder; pea protein (Nutralys S85F, Roquette); skimmed milk powder) have been evaluated using a Rapid Visco Analyzer (RVA—Perten Instruments model RVA 4). To 3.5 grams of the respective protein material, 21.5 grams of water were added in a RVA cup. Heating and stirring conditions were as in profile STD2 outlined in the Manufacturer's specifications (summarized in Table 28)

TABLE 28
RVA conditions

| Time | Type | Value | |
|---|---|---|---|
| 00:00:00 | Temp | 50° | C. |
| 00:00:00 | Speed | 960 | rpm |
| 00:00:10 | Speed | 160 | rpm |
| 00:01:00 | Temp | 50° | C. |
| 00:08:30 | Temp | 95° | C. |
| 00:13:30 | Temp | 95° | C. |
| 00:21:00 | Temp | 50° | C. |
| 00:23:00 | End | | |

Idle Temperature: 50° 1° C.
Time Between Readings: 4 s

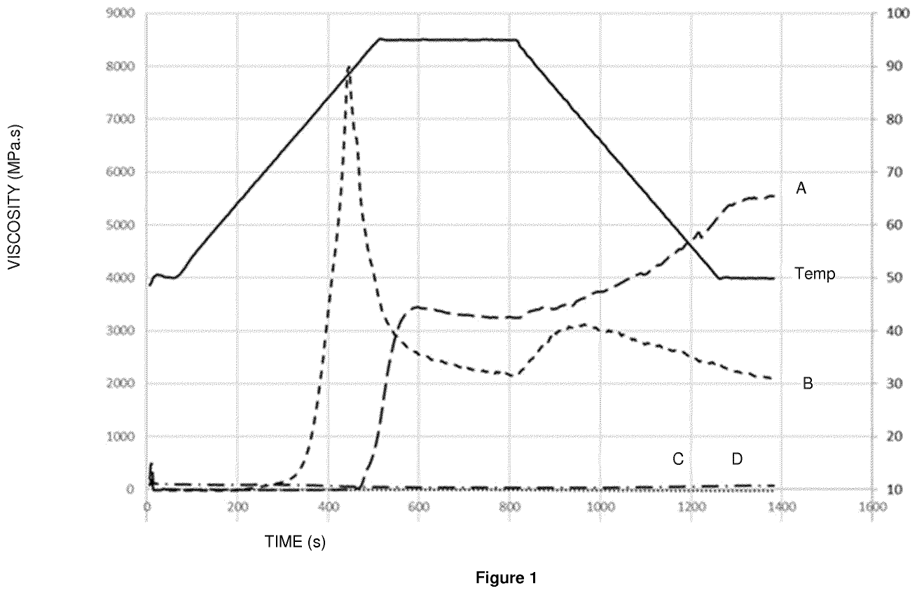

A graph showing the results of the analysis is presented in FIG. 1. Both pea protein and milk powder used show no viscosity increase upon heating, which indicated that they are non-gelling protein sources.

High ratio cakes are prepared using the chlorinated flour replacers of Table 29 and the batter compositions of Table 30. Cakes are prepared and cake texture properties are measured as described in Example 1.

TABLE 29
compositions of the chlorinated flour replacer used in Example
10 (expressed as % by weight of the chlorinated flour replacer)

| % (w/w) | A2 | B2 | C2 (*) | D2 (*) |
|---|---|---|---|---|
| Untreated soft wheat flour (ADM, USA) | 74 | 74 | 74 | 74 |
| Remyflo R7 90T CP | 22 | 22 | 22 | 22 |
| Whey protein (Nutrilac, Arla) | 3 | 0 | 0 | 0 |
| Egg white powder | 0 | 3 | 0 | 0 |
| Pea protein (Nutralys S85F, Roquette) | 0 | 0 | 3 | 0 |
| Skimmed milk powder | 0 | 0 | 0 | 3 |
| CaCl₂•2H₂O | 1 | 1 | 1 | 1 |

(*) comparative example

TABLE 30
cake batter compositions (expressed as % by weight of the batter)

| | RF10A | RF10B | RF10C(*) | RF10D(*) |
|---|---|---|---|---|
| Chlorinated flour replacer A2 | 24.5 | | | |
| of table 29 | | | | |
| Chlorinated flour replacer B2 | | 24.5 | | |
| of table 29 | | | | |
| Chlorinated flour replacer C2 | | | 24.5 | |
| of table 29 | | | | |
| Chlorinated flour replacer D2 | | | | 24.5 |
| of table 29 | | | | |
| Shortening | 1.2 | 1.2 | 1.2 | 1.2 |
| Mono- and diglycerides of | 2.0 | 2.0 | 2.0 | 2.0 |
| fatty acids (Puratos) | | | | |
| Sucrose | 21.1 | 21.1 | 21.1 | 21.1 |
| Egg White Powder | 1.9 | 1.9 | 1.9 | 1.9 |
| Egg Yolk Powder | 1.1 | 1.1 | 1.1 | 1.1 |
| Dextrose Monohydrate | 1.4 | 1.4 | 1.4 | 1.4 |
| Skimmed Milk Powder | 1.1 | 1.1 | 1.1 | 1.1 |
| Salt | 0.5 | 0.5 | 0.5 | 0.5 |
| Baking powder | 1.4 | 1.4 | 1.4 | 1.4 |
| Hydrocolloid | 0.1 | 0.1 | 0.1 | 0.1 |
| Oil | 6.5 | 6.5 | 6.5 | 6.5 |
| Water | 37.2 | 37.2 | 37.2 | 37.2 |

(*)comparative example

The resilience of the cakes is evaluated 24 hours after baking as described in Example 1. The results are presented in Table 31.

TABLE 31
resilience of cake crumb measured with the Texture Analyser (relative
value to the results obtained for RF10A that have been set to 100)

| | Resilience (%) |
|---|---|
| RF10A | 100 |
| RF10B | 103 |
| RF10C (comparative example) | 91 |
| RF10D (comparative example) | 91 |

These results show that the crumb resilience of high ratio cakes prepared with addition of non-gelling proteins is significantly lower than for cakes prepared with addition of gelling proteins.

### Example 11: Oat Flour

A chlorinated flour replacer RF11 is prepared by mixing 73% (w/w) untreated soft wheat flour (ADM, USA), 22% (w/w) oat flour (Pure Oat Flour OF, Raisio Nutrition, Finland); 3% (w/w) whey protein (Nutrilac, Arla) and 2% (w/w) CaCl₂.2H₂O.

High ratio cakes are prepared based on the REF3 batter compositions of example 3 using either untreated soft wheat flour (REF11) or the oat flour based chlorinated flour replacer (RF11).

The cakes were prepared and evaluated as described in example 1.

The hardness, resilience and chewiness of the RF11 cakes are respectively 139, 114 and 138 when the values of the control REF11 are set to 100.

The results show that oat flour is effective as non-wheat flour ingredient in the chlorinated flour replacer of the invention.

1. A flour improver for use in the preparation of wheat flour-based high ratio cakes comprising:
between 10% and 97.5% (w/w) of non-wheat flour, wherein the non-wheat flour is one or more non-wheat flours selected from the group consisting of rice flour, oat flour, quinoa flour and buckwheat flour;
between 2% and 20% (w/w) of a gel-forming protein in addition to protein present in the non-wheat flour, wherein the gel-forming protein has the ability to form a viscoelastic aggregate upon heating; and
between 0.5% and 3% (w/w) of calcium 2+ ions.

2. The flour improver according to claim 1, wherein the non-wheat flour is rice flour, preferably wet milled rice flour.

3. The flour improver according to claim 1 or 2 wherein the gel-forming protein in addition to the protein present in the non-wheat flour is one or more gel-forming proteins selected from the group consisting of egg protein, casein, gel-forming whey protein, isolated wheat gluten, oilseeds protein and legume protein.

4. The flour improver according to any one of claims 1 to 3, wherein the calcium 2+ ions are present in the form of one or more calcium salts.

5. The flour improver according to claim 4 wherein the calcium 2+ ions are present in the form of one or more calcium salts selected from the group consisting of calcium chloride, calcium acetate, calcium citrate, calcium lactate, calcium tartrate, calcium glubionate and calcium gluceptate.

6. A chlorinated flour replacer for use in the preparation of wheat flour-based high ratio cakes comprising the flour improver according to any one of claims 1 to 5; the chlorinated flour replacer comprising:
between 40% and 88.75% (w/w) of non-chlorinated wheat flour;
between 10% and 58% (w/w), preferably between 10% and 25% (w/w), of non-wheat flour, wherein the non-wheat flour is one or more non-wheat flours selected from the group consisting of rice flour, oat flour, quinoa flour and buckwheat flour;
between 1% and 10% (w/w), preferably between 2% and 4% (w/w), of the gel-forming protein in addition to protein present in the non-chlorinated wheat flour and the non-wheat flour, wherein the gel-forming protein has the ability to form a viscoelastic aggregate upon heating; and
between 0.25% and 1% (w/w), preferably between 0.25% and 0.8% (w/w), of calcium 2+ ions.

7. The chlorinated flour replacer according to claim 6, wherein the non-wheat flour is rice flour, preferably wet milled rice flour.

8. The chlorinated flour replacer according to claim 6 or 7, wherein the gel-forming protein in addition to the protein present in the non-chlorinated wheat flour and the non-wheat flour is one or more gel-forming proteins selected from the group consisting of egg protein, casein, gel-forming whey protein, isolated wheat gluten, oilseeds protein and legume protein.

9. The chlorinated flour replacer according to any one of claims 6 to 8, wherein the calcium 2+ ions are present in the form of one or more calcium salts, preferably selected from the group consisting of calcium chloride, calcium acetate, calcium citrate, calcium lactate, calcium tartrate, calcium glubionate and calcium gluceptate.

10. A cake mix or cake premix comprising the flour improver according to any one of claims 1 to 5 or the chlorinated flour replacer according to any one of claims 6 to 9.

11. A cake batter comprising the flour improver according to any one of claims 1 to 5, non-chlorinated wheat flour, fat, eggs or egg products, sugar or sugar substitutes, leavening agent and water; wherein the ratio (w/w) of liquid to flour is between 1 and 3.

12. The cake batter according to claim 11, comprising:
between 0.35% and 17.5% (w/w) of the flour improver according to any one of claims 1 to 5;
between 2.5% and 32.6% (w/w) of non-chlorinated wheat flour;
between 2% and 35% (w/w) of fat;
between 5% and 40% (w/w) of eggs or egg products;
between 10% and 40% (w/w) of sugar or sugar substitutes;
between 0% and 2.5% (w/w) of leavening agent; and
water up to 100%.

13. The cake batter according to claim 11 or 12, wherein the ratio (w/w) of sugar or sugar substitutes to flour is between 0.7 and 3.0.

14. The cake batter according to any one of claims 11 to 13, further comprising one or more emulsifiers, aroma components, flavour components, hydrocolloids, reducing agents, oxidants, yeast extract, enzyme active soy flour, starches, cocoa powder, chocolate, colouring agents, and/or enzymes.

15. A cake product prepared from the cake batter according to any one of claims 11 to 14, wherein said cake product is a wheat flour-based high ratio cake.

16. A method for preparing the flour improver according to any one of claims 1 to 5, comprising the step of preparing a mixture of at least:
between 10% and 97.5% (w/w) of non-wheat flour, wherein said non-wheat flour is one or more non-wheat flours selected from the group consisting of rice flour, oat flour, quinoa flour and buckwheat flour;
between 2% and 20% (w/w) of a gel-forming protein in addition to protein present in the non-chlorinated wheat flour and the non-wheat flour, wherein the gel-forming protein has the ability to form a viscoelastic aggregate upon heating; and
between 0.5% and 3% (w/w) of calcium 2+ ions,
thereby obtaining the flour improver according to any one of claims 1 to 5.

17. A method for preparing the chlorinated flour replacer according to any one of claims 6 to 9, comprising the step of preparing a mixture of at least:
between 40 and 88.75% (w/w), preferably between 70% and 80% (w/w) of non-chlorinated wheat flour;
between 10 and 58% (w/w), preferably between 10% and 25% (w/w), of non-wheat flour wherein said non-wheat flour is one or more non-wheat flours selected from the group consisting of rice flour, oat flour, quinoa flour and buckwheat flour;
between 1% and 10% (w/w), preferably between 2% and 4% (w/w), of a gel-forming protein in addition to protein present in the non-chlorinated wheat flour and the non-wheat flour, wherein the gel-forming protein has the ability to form a viscoelastic aggregate upon heating; and
between 0.25% and 1% (w/w), preferably between 0.25% and 0.8% (w/w), of calcium 2+ ions,
thereby obtaining the chlorinated flour replacer according to any one of claims 6 to 9.

18. A method for preparing a cake batter according to any one of claims 11 to 14, comprising the steps of adding the flour improver according to any one of claims 1 to 5 to non-chlorinated flour, fat, eggs or egg products, sugar or sugar substitutes, leavening agent and water and ensuring that the ratio (w/w) of liquid to flour is between 1 and 3, and optionally ensuring that the ratio (w/w) of sugar to flour is between 0.7 and 3.0; thereby obtaining the cake batter according to any one of claims 11 to 14.

19. A method for preparing a cake product according to claim 15, comprising the steps of providing a flour improver according to any one of claims 1 to 5 or a chlorinated flour replacer according to any one of claims 6 to 9; preparing a cake batter comprising the flour improver or the chlorinated flour replacer; and baking the cake batter, thereby obtaining the cake product according to claim 15.

20. Use of the flour improver according to any one of claims 1 to 5 or the chlorinated flour replacer according to any one of claims 6 to 9 as an ingredient in the preparation of a wheat flour-based high ratio cake, preferably wherein the flour improver or the chlorinated flour replacer is used as an ingredient of a cake mix or a cake premix.

21. Use of the flour improver according to any one of claims 1 to 5 or the chlorinated flour replacer according to any one of claims 6 to 9 for improving one or more textural properties or parameters of wheat flour-based high ratio cakes, preferably wherein the one or more textural properties or parameters are selected from the group consisting of hardness, resilience, springiness, cohesiveness, gumminess and chewiness of the cake product; and wherein the one or more texture parameters may be evaluated by performing a texture profile analysis on a cake crumb sample obtained from the cake product or the whole (i.e. entire) cake product; or by performing a sensorial analysis by a panel of trained and/or untrained persons.

22. Use according to claim 21 for increasing the resilience of a wheat flour-based high ratio cake by at least 20%, preferably at least 30%, more preferably at least 40%, compared to the resilience of a reference wheat flour-based high ratio cake, wherein said reference high ratio cake is a high ratio cake prepared using untreated wheat flour instead of the chlorinated flour replacer; wherein the resilience is evaluated from the force-time curve registered when performing a texture profile analysis comprising two consecutive deformation on a cake sample.

23. Use according to claim 21 for increasing the chewiness of a wheat flour-based high ratio cake by at least 30%, preferably at least 40%, compared to the chewiness of a reference wheat flour-based high ratio cake, preferably wherein said reference high ratio cake is a high ratio cake prepared using untreated wheat flour instead of the chlorinated flour replacer; wherein the chewiness is evaluated from the force-time curve registered when performing a texture profile analysis comprising two consecutive deformations on a cake sample.
